(19) United States
(12) Patent Application Publication
(10) Pub. No.: US 2025/0365570 A1
(43) Pub. Date: Nov. 27, 2025

(54) UPLINK MULTIPLEXING AND ANTENNA PORT MAPPING FOR MULTIPLE SUBSCRIPTIONS

(71) Applicant: QUALCOMM INCORPORATED, San Diego, CA (US)

(72) Inventors: Shaohui JING, Beijing (CN); Tom CHIN, San Diego, CA (US); Wei GUO, Beijing (CN); Guixin HAN, Beijing (CN); Jing CAO, Beijing (CN)

(21) Appl. No.: 18/874,529

(22) PCT Filed: Aug. 24, 2022
(86) PCT No.: PCT/CN2022/114425

§ 371 Date: Dec. 12, 2024

(51) Int. Cl. H04W 8/18; H04W 72/044

(52) U.S. Cl. CPC H04W 8/18; H04W 72/044

(57) ABSTRACT

Methods, systems, and devices for wireless communications are described. A user equipment (UE) may activate a dual-subscription dual-active mode that enables the UE to communicate uplink signals such as sounding reference signals (SRS) using at least two subscriptions via one or more antenna ports of the UE. The UE may transmit, using a first antenna port, a first uplink signal associated with a first subscription of the UE multiplexed on a first set of uplink resources with a second uplink signal associated with a second subscription of the UE. The UE may then transmit, using a second antenna port, the first uplink signal associated with the first subscription multiplexed on the set of uplink resources with the second uplink signal associated with the second subscription.

### CROSS REFERENCE

The present application is a 371 national stage filing of International PCT Application No. PCT/CN2022/114425 by JING et al. entitled “UPLINK MULTIPLEXING AND ANTENNA PORT MAPPING FOR MULTIPLE SUBSCRIPTIONS,” filed Aug. 24, 2022, which is assigned to the assignee hereof, and which is expressly incorporated by reference in its entirety herein.

### FIELD OF TECHNOLOGY

The following relates to wireless communications, including uplink multiplexing and antenna port mapping for multiple subscriptions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support uplink multiplexing and antenna port mapping for multiple subscriptions. For example, the described techniques provide support for communications at a user equipment (UE) capable of operating using two or more subscriber identity modules (SIMs) or subscriptions. In some cases, the UE may implement a dual-SIM dual-active (DSDA) mode, such that the UE is actively connected to two different subscribed networks. To increase the performance of the DSDA mode, the UE may enable sharing between radio frequency (RF) transmission (Tx) ports for transmitting sounding reference signals (SRS). For example, two RF Tx ports may be available for SRS transmissions for each subscription. The UE may transmit SRS associated with a first subscription via a first RF Tx port that is multiplexed with a second SRS associated with a second subscription. Similarly, the UE may transmit the SRS associated with a first subscription via a second RF Tx port that is multiplexed with the second SRS associated with a second subscription. Additionally or alternatively, the UE may multiplex SRS associated with the different subscription in time or frequency using non-overlapping resources allocated by the network.

A method for wireless communications at a UE is described. The method may include activating a dual-subscriber dual-active mode (e.g., a DSDA mode) for the UE to communicate using at least two subscriptions of the UE via one or more antenna ports of the UE, transmitting, via a first antenna port of the one or more antenna ports of the UE and using a set of time-frequency resources, a first uplink signal associated with a first subscription of the at least two subscriptions multiplexed with a second uplink signal associated with a second subscription of the at least two subscriptions based on activation of the dual-subscriber dual-active mode, and transmitting, via a second antenna port of the one or more antenna ports of the UE and using the set of time-frequency resources, the first uplink signal associated with the first subscription of the at least two subscriptions multiplexed with the second uplink signal associated with the second subscription of the at least two subscriptions of the UE based on activation of the dual-subscriber dual-active mode.

An apparatus for wireless communications at a UE is described. The apparatus may include a processor, memory coupled with the processor, and instructions stored in the memory. The instructions may be executable by the processor to cause the apparatus to activate a dual-subscriber dual-active mode for the UE to communicate using at least two subscriptions of the UE via one or more antenna ports of the UE, transmit, via a first antenna port of the one or more antenna ports of the UE and using a set of time-frequency resources, a first uplink signal associated with a first subscription of the at least two subscriptions multiplexed with a second uplink signal associated with a second subscription of the at least two subscriptions based on activation of the dual-subscriber dual-active mode, and transmit, via a second antenna port of the one or more antenna ports of the UE and using the set of time-frequency resources, the first uplink signal associated with the first subscription of the at least two subscriptions multiplexed with the second uplink signal associated with the second subscription of the at least two subscriptions of the UE based on activation of the dual-subscriber dual-active mode.

Another apparatus for wireless communications at a UE is described. The apparatus may include means for activating a dual-subscriber dual-active mode for the UE to communicate using at least two subscriptions of the UE via one or more antenna ports of the UE, means for transmitting, via a first antenna port of the one or more antenna ports of the UE and using a set of time-frequency resources, a first uplink signal associated with a first subscription of the at least two subscriptions multiplexed with a second uplink signal associated with a second subscription of the at least two subscriptions based on activation of the dual-subscriber dual-active mode, and means for transmitting, via a second antenna port of the one or more antenna ports of the UE and using the set of time-frequency resources, the first uplink signal associated with the first subscription of the at least two subscriptions multiplexed with the second uplink signal associated with the second subscription of the at least two subscriptions of the UE based on activation of the dual-subscriber dual-active mode.

A non-transitory computer-readable medium storing code for wireless communications at a UE is described. The code may include instructions executable by a processor to activate a dual-subscriber dual-active mode for the UE to communicate using at least two subscriptions of the UE via one or more antenna ports of the UE, transmit, via a first antenna port of the one or more antenna ports of the UE and using a set of time-frequency resources, a first uplink signal associated with a first subscription of the at least two subscriptions multiplexed with a second uplink signal associated with a second subscription of the at least two subscriptions based on activation of the dual-subscriber dual-active mode, and transmit, via a second antenna port of the one or more antenna ports of the UE and using the set of time-frequency resources, the first uplink signal associated with the first subscription of the at least two subscriptions multiplexed with the second uplink signal associated with the second subscription of the at least two subscriptions of the UE based on activation of the dual-subscriber dual-active mode.

Some examples of the method, apparatuses, and non-transitory computer-readable medium described herein may further include operations, features, means, or instructions for transmitting, via the first antenna port of the one or more antenna ports of the UE and using a first set of time resources of the set of time-frequency resources, the first uplink signal associated with the first subscription multiplexed in time with the second uplink signal associated with the second subscription and transmitting, via the second antenna port of the one or more antenna ports of the UE and using a second set of time resources of the set of time-frequency resources, the first uplink signal associated with the first subscription multiplexed in time with the second uplink signal associated with the second subscription.

Some examples of the method, apparatuses, and non-transitory computer-readable medium described herein may further include operations, features, means, or instructions for receiving a resource allocation message indicating the first set of time resources and the second set of time resources, where the first set of time resources and the second set of time resources may be non-overlapping in time.

Some examples of the method, apparatuses, and non-transitory computer-readable medium described herein may further include operations, features, means, or instructions for transmitting, via the first antenna port of the one or more antenna ports of the UE and using a first set of frequency resources of the set of time-frequency resources, the first uplink signal associated with the first subscription multiplexed in frequency with the second uplink signal associated with the second subscription and transmitting, via the second antenna port of the one or more antenna ports of the UE and using a second set of frequency resources of the set of time-frequency resources, the first uplink signal associated with the first subscription multiplexed in frequency with the second uplink signal associated with the second subscription.

Some examples of the method, apparatuses, and non-transitory computer-readable medium described herein may further include operations, features, means, or instructions for receiving a resource allocation message indicating the first set of frequency resources and the second set of frequency resources, where the first set of frequency resources and the second set of frequency resources may be non-overlapping in frequency.

Some examples of the method, apparatuses, and non-transitory computer-readable medium described herein may further include operations, features, means, or instructions for transmitting a UE assistance information (UAI) message that includes a request for allocating the set of time-frequency resources that may be non-overlapping in time and transmitting the first uplink signal associated with the first subscription and the second uplink signal associated with the second subscription via the first antenna port and the second antenna port of the one or more antenna ports of the UE using the set of time-frequency resources that may be non-overlapping in time based on the UAI message.

Some examples of the method, apparatuses, and non-transitory computer-readable medium described herein may further include operations, features, means, or instructions for transmitting the request for allocating the set of time-frequency resources in at least one field of the UAI message.

In some examples of the method, apparatuses, and non-transitory computer-readable medium described herein, the at least one field of the UAI message includes a non-critical extension field.

In some examples of the method, apparatuses, and non-transitory computer-readable medium described herein, the UAI message further includes a preferred time slot for transmission of the first uplink signal and the second uplink signal, a periodicity for transmission of the first uplink signal and the second uplink signal, an offset for transmission of the first uplink signal and the second uplink signal, an indication of a change of the set of time-frequency resources to a different set of time-frequency resources, or any combination thereof.

Some examples of the method, apparatuses, and non-transitory computer-readable medium described herein may further include operations, features, means, or instructions for receiving an indication of the set of time-frequency resources that further indicates resources allocated for switching between the first antenna port and the second antenna port of the one or more antenna ports of the UE, the set of time-frequency resources associated with the first subscription and the second subscription at least partially overlapping in time and transmitting the UAI message that includes the request for allocating the set of time-frequency resources that may be non-overlapping in time based on the indication.

Some examples of the method, apparatuses, and non-transitory computer-readable medium described herein may further include operations, features, means, or instructions for receiving an updated set of time-frequency resources that may be non-overlapping in time based on the UAI message.

Some examples of the method, apparatuses, and non-transitory computer-readable medium described herein may further include operations, features, means, or instructions for receiving a control information message that includes a listing of time-frequency resources including the set of time-frequency resources, where the listing of time-frequency resources may be non-overlapping time-frequency resources to use for transmission of the first uplink signal associated with a first subscription and for transmission of the second uplink signal associated with the second subscription.

In some examples of the method, apparatuses, and non-transitory computer-readable medium described herein, the listing of time-frequency resources may be non-overlapping based on slot offset of the non-overlapping time-frequency resources, periodicity of the non-overlapping time-frequency resources, or both.

In some examples of the method, apparatuses, and non-transitory computer-readable medium described herein, the first antenna port may be associated with the first subscription and the second antenna port may be associated with the second subscription.

In some examples of the method, apparatuses, and non-transitory computer-readable medium described herein, the dual-subscriber dual-active mode may be associated with an activated UE capability.

In some examples of the method, apparatuses, and non-transitory computer-readable medium described herein, the first uplink signal and the second uplink signal include one or more sounding reference signals.

A method for wireless communications at a network entity is described. The method may include receiving, from a UE, a UAI message that includes a request for allocating a set of time-frequency resources that are non-overlapping in time, frequency, or both and receiving, via the set of time-frequency resources, a first uplink signal associated with a first subscription of the UE multiplexed with a second uplink signal associated with a second subscription of the UE.

An apparatus for wireless communications at a network entity is described. The apparatus may include a processor, memory coupled with the processor, and instructions stored in the memory. The instructions may be executable by the processor to cause the apparatus to receive, from a UE, a UAI message that includes a request for allocating a set of time-frequency resources that are non-overlapping in time, frequency, or both and receive, via the set of time-frequency resources, a first uplink signal associated with a first subscription of the UE multiplexed with a second uplink signal associated with a second subscription of the UE.

Another apparatus for wireless communications at a network entity is described. The apparatus may include means for receiving, from a UE, a UAI message that includes a request for allocating a set of time-frequency resources that are non-overlapping in time, frequency, or both and means for receiving, via the set of time-frequency resources, a first uplink signal associated with a first subscription of the UE multiplexed with a second uplink signal associated with a second subscription of the UE.

A non-transitory computer-readable medium storing code for wireless communications at a network entity is described. The code may include instructions executable by a processor to receive, from a UE, a UAI message that includes a request for allocating a set of time-frequency resources that are non-overlapping in time, frequency, or both and receive, via the set of time-frequency resources, a first uplink signal associated with a first subscription of the UE multiplexed with a second uplink signal associated with a second subscription of the UE.

Some examples of the method, apparatuses, and non-transitory computer-readable medium described herein may further include operations, features, means, or instructions for receiving, via a first set of time resources of the set of time-frequency resources, the first uplink signal associated with the first subscription multiplexed in time with the second uplink signal associated with the second subscription and receiving, via a second set of time resources of the set of time-frequency resources, the first uplink signal associated with the first subscription multiplexed in time with the second uplink signal associated with the second subscription.

Some examples of the method, apparatuses, and non-transitory computer-readable medium described herein may further include operations, features, means, or instructions for transmitting a resource allocation message indicating the first set of time resources and the second set of time resources, where the first set of time resources and the second set of time resources may be non-overlapping in time.

Some examples of the method, apparatuses, and non-transitory computer-readable medium described herein may further include operations, features, means, or instructions for receiving, via a first set of frequency resources of the set of time-frequency resources, the first uplink signal associated with the first subscription multiplexed in frequency with the second uplink signal associated with the second subscription and receiving, via a second set of frequency resources of the set of time-frequency resources, the first uplink signal associated with the first subscription multiplexed in frequency with the second uplink signal associated with the second subscription.

Some examples of the method, apparatuses, and non-transitory computer-readable medium described herein may further include operations, features, means, or instructions for transmitting a resource allocation message indicating the first set of frequency resources and the second set of frequency resources, where the first set of frequency resources and the second set of frequency resources may be non-overlapping in frequency.

Some examples of the method, apparatuses, and non-transitory computer-readable medium described herein may further include operations, features, means, or instructions for receiving the request for allocating the set of time-frequency resources in at least one field of the UAI message, where the at least one field of the UAI message includes a non-critical extension field.

In some examples of the method, apparatuses, and non-transitory computer-readable medium described herein, the UAI message further includes a preferred time slot for transmission of the first uplink signal and the second uplink signal, a periodicity for transmission of the first uplink signal and the second uplink signal, and offset for transmission of the first uplink signal and the second uplink signal, an indication of a change of the set of time-frequency resources to a different set of time-frequency resources, or any combination thereof.

Some examples of the method, apparatuses, and non-transitory computer-readable medium described herein may further include operations, features, means, or instructions for transmitting an indication of the set of time-frequency resources that further indicates resources allocated for switching between a first antenna port and a second antenna port of one or more antenna ports of the UE, the set of time-frequency resources associated with the first subscription and the second subscription at least partially overlapping in time and receiving the UAI message that includes the request for allocating the set of time-frequency resources that may be non-overlapping in time based on the indication.

Some examples of the method, apparatuses, and non-transitory computer-readable medium described herein may further include operations, features, means, or instructions for transmitting an updated set of time-frequency resources that may be non-overlapping in time based on the UAI message.

Some examples of the method, apparatuses, and non-transitory computer-readable medium described herein may further include operations, features, means, or instructions for transmitting a control information message that includes a listing of time-frequency resources including the set of time-frequency resources, where the listing of time-frequency resources may be non-overlapping time-frequency resources to use for transmission of the first uplink signal associated with a first subscription and for transmission of the second uplink signal associated with the second subscription.

In some examples of the method, apparatuses, and non-transitory computer-readable medium described herein, the listing of time-frequency resources may be non-overlapping based on slot offset of the non-overlapping time-frequency resources, periodicity of the non-overlapping time-frequency resources, or both.

In some examples of the method, apparatuses, and non-transitory computer-readable medium described herein, the first uplink signal and the second uplink signal include one or more SRS.

### BRIEF DESCRIPTION OF THE DRAWINGS

FIGS. 1 and 2 illustrate examples of wireless communications systems that support uplink multiplexing and antenna port mapping for multiple subscriptions in accordance with one or more aspects of the present disclosure.

FIG. 3 illustrates example antenna port multiplexing configurations that support uplink multiplexing and antenna port mapping for multiple subscriptions in accordance with one or more aspects of the present disclosure.

FIGS. 4 and 5 illustrate example sounding reference signal (SRS) multiplexing configurations that support uplink multiplexing and antenna port mapping for multiple subscriptions in accordance with one or more aspects of the present disclosure.

FIG. 6 illustrates an example of a decision flow diagram that supports uplink multiplexing and antenna port mapping for multiple subscriptions in accordance with one or more aspects of the present disclosure.

FIGS. 7 and 8 illustrates example process flows that support uplink multiplexing and antenna port mapping for multiple subscriptions in accordance with one or more aspects of the present disclosure.

FIGS. 9 and 10 show block diagrams of devices that support uplink multiplexing and antenna port mapping for multiple subscriptions in accordance with one or more aspects of the present disclosure.

FIG. 11 shows a block diagram of a communications manager that supports uplink multiplexing and antenna port mapping for multiple subscriptions in accordance with one or more aspects of the present disclosure.

FIG. 12 shows a diagram of a system including a device that supports uplink multiplexing and antenna port mapping for multiple subscriptions in accordance with one or more aspects of the present disclosure.

FIGS. 13 and 14 show block diagrams of devices that support uplink multiplexing and antenna port mapping for multiple subscriptions in accordance with one or more aspects of the present disclosure.

FIG. 15 shows a block diagram of a communications manager that supports uplink multiplexing and antenna port mapping for multiple subscriptions in accordance with one or more aspects of the present disclosure.

FIG. 16 shows a diagram of a system including a device that supports uplink multiplexing and antenna port mapping for multiple subscriptions in accordance with one or more aspects of the present disclosure.

FIGS. 17 and 18 show flowcharts illustrating methods that support uplink multiplexing and antenna port mapping for multiple subscriptions in accordance with one or more aspects of the present disclosure.

### DETAILED DESCRIPTION

Some wireless communications devices such as user equipment (UE) may be configured to support two or more subscriber identity modules (SIMs) or subscriptions to identify and authenticate subscribed users of the different services of a wireless communications network. For example, the two or more subscriptions may enable a UE to the establish and communicate using two or more different voice or data networks, which may improve service quality, increase throughput, etc. In some cases, the UE may support a dual-SIM dual-active (DSDA) mode, where the UE may be actively connected to two different subscribed networks. For example, the UE may transmit or receive communications using a first subscription (e.g., a first SIM) and using a second subscription (e.g., a second SIM) concurrently or simultaneously.

In some cases, the UE may perform channel sounding to establish a secure connection using both subscriptions used in DSDA mode. A network entity may configure the UE for antenna switching for sending SRS (e.g., in scenarios where the number of transmission antennas is less than the number of receive antennas at the UE). In some cases, however, the UE may report SRS on a single port for each subscription using two uplink radio frequency (RF) chains available for the UE. In such cases, each subscription may access a single transmission (Tx) chain, leading to the UE sending a portion of the SRS associated with each subscription. As the network may not receive the full SRS, the network entity may incorrectly estimate a precoding matrix for the communications channel, which may increase channel error and reduce overall signaling performance.

To increase the performance and efficiency of the DSDA capability for the UE, and to support accurate channel sounding for SRS associated with each subscription, the UE may enable sharing of RF ports for transmission of SRS associated with the two subscriptions. For example, a first RF Tx port and a second RF Tx port may be used for antenna switching in DSDA mode for transmitting SRS associated with the two subscriptions. In such examples, two RF Tx ports are available for SRS transmissions of each subscription. In some implementations, a first antenna port (e.g., Port0) may be available for SRS transmissions of the first subscription and for SRS transmissions of the second subscription. Similarly, a second antenna port (e.g., Port1) may be available for SRS transmissions of the first subscription and for SRS transmissions of the second subscription. To further support efficient SRS signaling in DSDA mode, the UE may perform time multiplexing, frequency multiplexing, or both for transmitting SRS on each Tx port for each subscription. For example, in some cases, the UE may transmit a message, such as a UE assistance information (UAI) message, to request an allocation of non-overlapping SRS resources so that the UE can reuse the first subscription SRS and the second subscription SRS with time or frequency multiplexing on the same or at least partially overlapping RF resources.

Aspects of the disclosure are initially described in the context of wireless communications systems. Aspects of the disclosure are further illustrated by and described with reference to antenna port multiplexing configurations, SRS multiplexing configurations, a decision flow, process flows, apparatus diagrams, system diagrams, and flowcharts that relate to uplink multiplexing and antenna port mapping for multiple subscriptions.

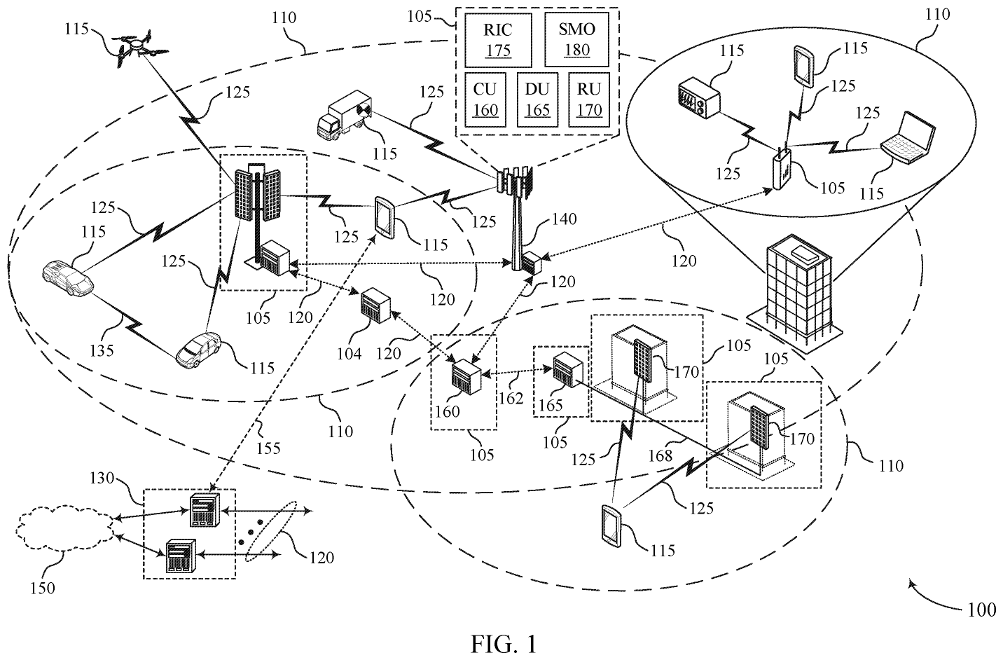

FIG. 1 illustrates an example of a wireless communications system 100 that supports uplink multiplexing and antenna port mapping for multiple subscriptions in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., an RF access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support uplink multiplexing and antenna port mapping for multiple subscriptions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Some UE 115 may be configured to support two or more subscriptions that enable a UE 115 to the establish and communicate on two or more different voice or data networks of the wireless communications system 100. In some cases, the UE 115 may support a DSDA mode, where the UE 115 may be actively connected to two different subscribed networks (e.g., each subscription associated with a respective network). For example, the UE 115 may transmit or receive communications using a first subscription and using a second subscription concurrently. In some cases, the UE 115 may perform channel sounding to establish a secure connection using both subscriptions used in DSDA mode. A network entity 105 may configure the UE 115 for antenna switching for sending SRS. In some cases, however, the UE 115 may report SRS on a single antenna port for each subscription using two uplink RF chains that are available for use by the UE 115. In such cases, each subscription may access a single Tx chain, leading to the UE 115 sending only a portion of the SRS associated with each subscription. In such instances, without receiving the full SRS, the network entity 105 may incorrectly estimate a precoding matrix for the communications channel, which may increase channel error.

To increase the performance and efficiency of the DSDA capability for the UE 115, the UE 115 may enable sharing of RF ports for transmission of SRS associated with the two subscriptions. For example, a first RF Tx port and a second RF Tx port may be used for antenna switching in DSDA mode for transmitting SRS associated with the two subscriptions. In such examples, two RF Tx ports are available for SRS transmissions of each subscription. In some implementations, a first antenna port may be available for SRS transmissions of the first subscription and for SRS transmissions of the second subscription. Similarly, a second antenna port may be available for SRS transmissions of the first subscription and for SRS transmissions of the second subscription. To further support efficient SRS signaling in DSDA mode, the UE 115 may perform time multiplexing, frequency multiplexing, or both for transmitting SRS on each Tx port for multiple subscriptions. For example, in some cases, the UE 115 may transmit a UAI message to request an allocation of non-overlapping SRS resources so that the UE 115 can reuse the first subscription SRS and the second subscription SRS with time or frequency multiplexing on the same RF resources.

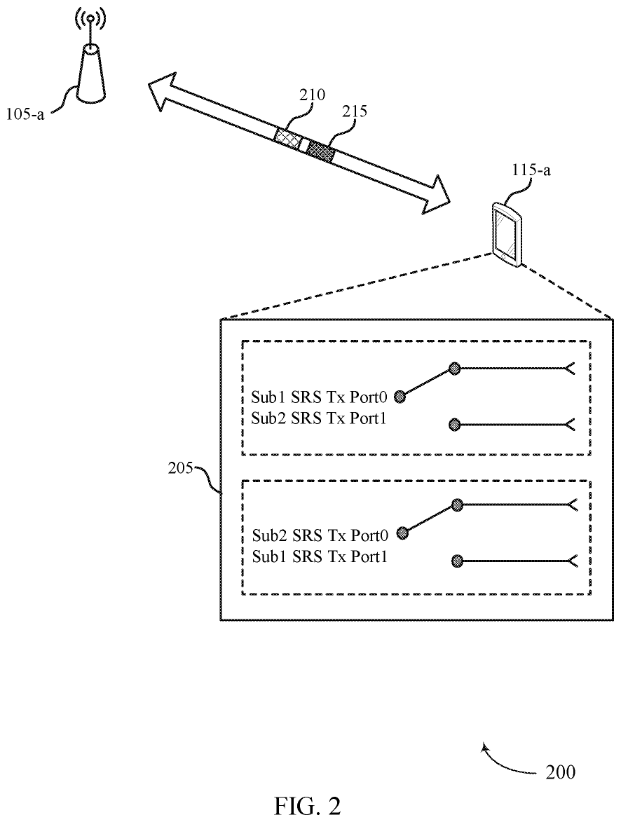

FIG. 2 illustrates an example of a wireless communications system 200 that supports uplink multiplexing and antenna port mapping for multiple subscriptions in accordance with one or more aspects of the present disclosure. For example, wireless communications system 200 may support communications between a UE 115-a and a network entity 105-a, each of which may be examples of corresponding devices described herein

The UE 115-a may be configured to support two or more SIMs or subscriptions that may be used to identify and authenticate subscribed users of the different services offered by operators of the network. In some examples, the two or more subscriptions supported by the UE 115-a may enable the establishment of communications on two or more different voice or data networks, such that the UE 115-a may maintain two or more subscription connections (e.g., active voice calls, active data communications) concurrently. The use of multiple subscriptions may allow the UE 115-a to access and use features of different subscriptions to reduce cost and increase service quality and user experience.

The UE 115-a may support several different operational modes associated with the multiple subscriptions. For example, in DSDA mode, the UE 115-a may be concurrently connected to multiple different subscribed networks, which may enable the UE 115-a to switch between multiple active connections at the same time or within a given time duration. For example, the UE 115-a may transmit or receive communications on a first subscription (e.g., Sub1) and a second subscription (e.g., Sub2) simultaneously. For example, in DSDA mode, the UE 115-a may establish a first active call on a first subscribed network and may receive a second call through a second subscribed network. If calls are simultaneously active on the first and second subscribed networks, the UE 115-a may switch between the two calls.

A UE 115-a may include two or more RF transceivers which may be operated independently and used for establishing and maintaining an active connection with the network entity 105-a on behalf of subscriptions. The RF transceivers may include both Tx chain and Rx chains for transmitting uplink communications and receiving downlink communications.

In some cases, the network entity 105-a may configure the UE 115-a for antenna switching for sending SRS in cases that the number of transmission antennas is less than the number of receive antennas (for example, in a two-transmission four-reception (2T4R) implementation at the UE 115-a). In some examples, the UE 115-a may report this antenna switching capability to the network entity 105-a and may switch between transmit and receive antennas for transmitting SRS. In some cases, however, the UE 115-a may report SRS on a single port for each subscription since the UE 115-a has 2 uplink RF chains available. For example, the UE 115-a may transmit SRS for a first subscription on a first antenna port and then may transmit SRS from a second subscription on a second antenna port. In such cases, each subscription may access a single Tx chain, leading to the UE 115-a sending a portion of the SRS associated with each subscription. Then, without the full SRS, the network entity 105-a may incorrectly estimate a precoding matrix for the communications channel, which may increase downlink block error rate (BLER) and reduce overall rank scheduling (e.g., low layer scheduling).

To increase the performance and efficacy of the DSDA capability for the UE 115-a, and to support accurate channel sounding for SRS associated with each subscription, the UE 115-a may support sharing RF ports for transmission of the two subscriptions. For example, the UE 115-a may support port configurations 205 in cases where the first subscription and the second subscription are associated with the same cell. In port configurations 205, RF Tx port 0 (e.g., antenna Port0) and RF Tx port 1 (e.g., antenna Port1) are used for antenna switching in DSDA mode for transmitting SRS associated with the two subscriptions. In such examples, two RF ports are available for SRS transmissions of each subscription. For example, a first antenna port (e.g., Port0) may be available for SRS transmissions 210 of the first subscription (e.g., Sub1) and for SRS transmissions 215 of the second subscription (e.g., Sub2). Similarly, a second antenna port (e.g., Port1) may be available for SRS transmissions 210 of the first subscription (e.g., Sub1) and for SRS transmissions 215 of the second subscription (e.g., Sub2). In some other examples, the UE 115-a may support time multiplexing, frequency multiplexing, or both for transmitting SRS on each Tx port for each subscription. For example, in some cases the UE 115-a may transmit a UAI message to request an allocation of non-overlapping SRS resources so that the UE 115-a can reuse Sub1 and Sub2 SRS with time (or frequency) multiplexing on the same RF resources for uplink SRS transmission in the time or frequency domain.

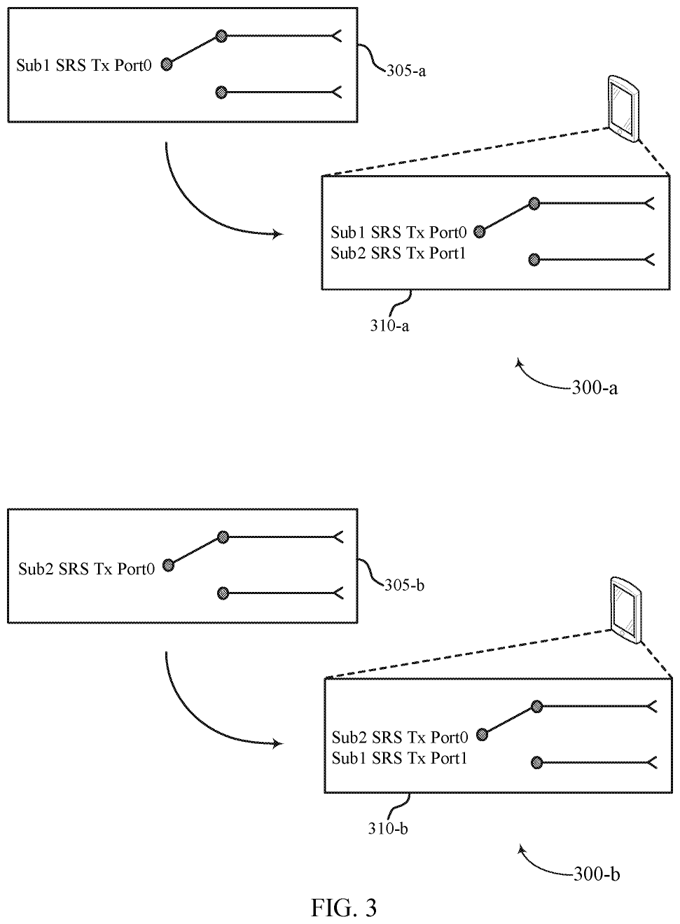

FIG. 3 illustrates an example of antenna port multiplexing configurations 300-a and 300-b that support uplink multiplexing and antenna port mapping for multiple subscriptions in accordance with one or more aspects of the present disclosure. For example, antenna port multiplexing configurations 300-a and 300-b may be implemented by a UE as described herein. In some examples, the UE may be capable of supporting a DSDA mode.

In some examples, for example, in configurations 305-a and 305-b, the UE may dedicate one Tx port for the first subscription (e.g., Sub1) and to a second subscription (e.g., Sub2). For example, the UE may transmit SRS associated with the first subscription and the second subscription via a first antenna port (e.g., Port0). To support 2T4R implementations for SRS antenna switching, the UE may share RF Tx Port0 and RF TX Port1 for SRS transmissions of each subscription. For example, in configuration 310-a, the UE may support antenna switching so that the UE may send SRS on Port0 for a first subscription and may also send SRS on Port1 for a second subscription. Similarly, in configuration 310-b, the UE may support antenna switching so that the UE may send SRS on Port0 for the second subscription and may also send SRS on Port1 for the first subscription.

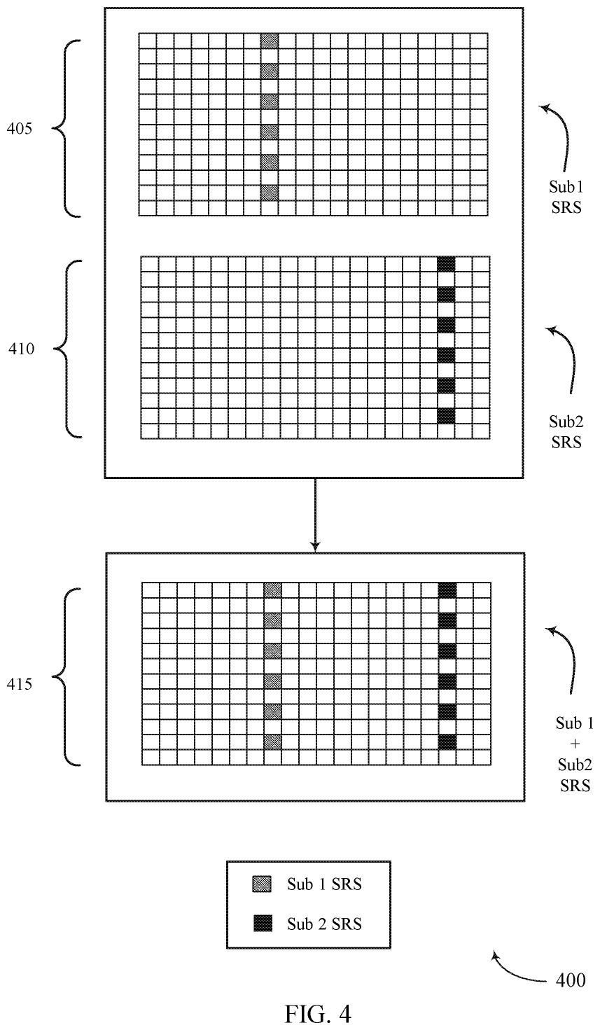

FIG. 4 illustrates an example of an SRS multiplexing configuration 400 that supports uplink multiplexing and antenna port mapping for multiple subscriptions in accordance with one or more aspects of the present disclosure. For example, SRS multiplexing configuration 400 may be configured by or implemented at a wireless device or a network device such as a UE or a network entity as described herein.

In some examples, a UE may reuse Sub1 and Sub2 SRS on each Tx port with time multiplexing on the same RF resources such that two Tx ports are available for each subscription. For example, the UE may have SRS resources 405 associated with Sub1 (e.g., Sub1 SRS) allocated for transmission during a time and on a first set of frequencies, and may have SRS resources 410 associated with Sub2 (e.g., Sub2 SRS) allocated for transmission during a second time and on the first set of frequencies. In such examples, the UE may transmit the SRS from Sub1 and Sub2 with time multiplexing on SRS resources 415 such that the Sub1 SRS and the Sub2 SRS are transmitted on the same frequencies, but multiplexed in time. To support time multiplexing for SRS resources, the SRS resources may be allocated or selected such that the SRS resources are non-overlapping in the time domain.

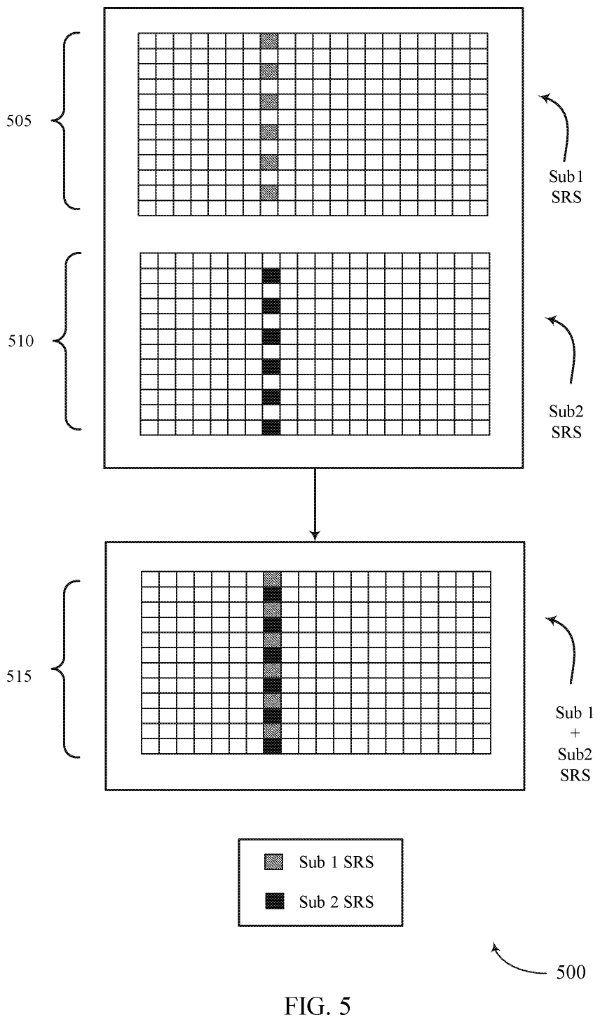

FIG. 5 illustrates an example of an SRS multiplexing configuration 500 that supports uplink multiplexing and antenna port mapping for multiple subscriptions in accordance with one or more aspects of the present disclosure. For example, SRS multiplexing configuration 500 may be configured by or implemented at a wireless device or a network device such as a UE or a network entity as described herein.

In some examples, a UE may reuse Sub1 and Sub2 SRS on each Tx port with frequency multiplexing on the same RF resources such that two Tx ports are available for each subscription. For example, the UE may have SRS resources 505 associated with Sub1 (e.g., Sub1 SRS) allocated for transmission during a first time and a first set of frequencies, and may have SRS resources 510 associated with Sub2 (e.g., Sub2 SRS) allocated for transmission during the first time and on a second set of frequencies. In such examples, the UE may transmit the SRS from Sub1 and Sub2 with frequency multiplexing on SRS resources 515 such that the Sub1 SRS and the Sub2 SRS are transmitted at the same time, but multiplexed in frequency. To support frequency multiplexing for SRS resources, the SRS resources may be allocated or selected such that the SRS resources are non-overlapping in the frequency domain.

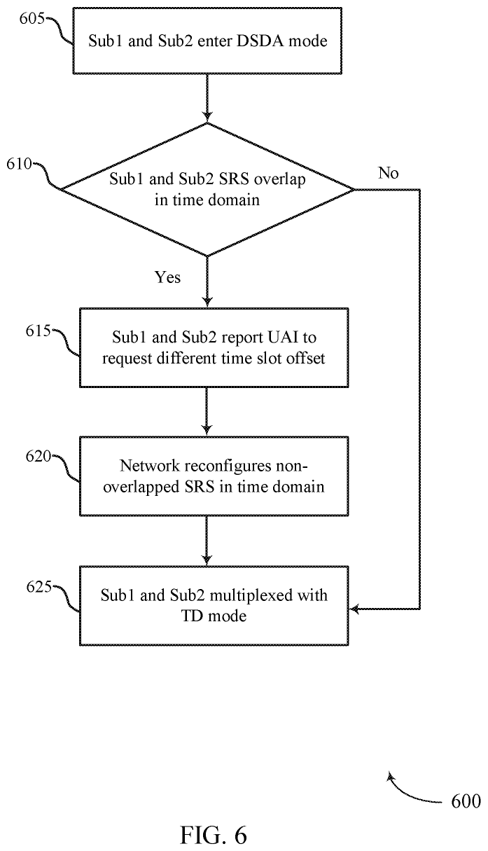

FIG. 6 illustrates an example of a decision flow 600 that supports uplink multiplexing and antenna port mapping for multiple subscriptions in accordance with one or more aspects of the present disclosure. In some examples, decision flow 600 may implement aspects of wireless communications system 100 or 200. The decision flow 600 may implemented by a UE, which may each be an example of a UE 115 as described herein. Alternative examples of the following process flow may be implemented, where some steps are performed in a different order than described or are not performed at all. In some cases, steps may include additional features not mentioned below, or further steps may be added.

At 605, the multi-subscriber UE may enter a DSDA mode by enabling a first subscription and a second subscription (e.g., Sub1 and Sub2).

At 610, the UE may determine whether SRS transmissions from the first subscription and the second subscription overlap (or are scheduled to overlap) in the time domain. In cases that the UE determines that the SRS transmissions from the first subscription and the second subscription are non-overlapping, the UE may skip to step 625, and may multiplex the SRS transmissions from the first subscription and the second subscription using time domain multiplexing (e.g., TD mode). In cases that the UE determines that the SRS transmissions from the first subscription and the second subscription at least partially overlap (e.g., the network allocates uplink resources for Sub1 SRS and Sub2 SRS to be at least partially overlapping), the UE may move to step 615.

At 615, the UE may report UAI to request non-overlapping SRS in the time domain including, for example, SRS with a different time slot offset. For example, in some cases the UE may transmit the UAI to request the network to allocate non-overlapping SRS in the time domain, such that Sub1 and Sub2 SRS may be reused with time multiplexing on the same RF resources by the UE for uplink SRS transmission in the time domain.

In some examples, the UE may transmit the request for non-overlapping SRS resources in a field of the UAI such as in the nonCriticalExtension field. The request may indicate a non-overlapping SRS resource in the time domain that the UE requests for the connected subscription (e.g., Sub1, Sub2, or both), such as a preferred time slot of SRS for these subscriptions. In such examples, the UE and the network may support extension of bits or bit strings in the UAI noncriticalEaentension field (e.g., UEAssistanceInformation-v1540-Ies->nonCriticalExtension). In some cases, the UE may request the non-overlapping SRS resources based on an aggregated evaluation of two subscriptions, which may support enhanced performance on both subscriptions, especially in cases where one subscription is operating in a connected state and another subscription is operating in an idle state on the same serving cell.

In some cases, the UE may report UAI to also indicate delay budget report, CDRX length or overheating assistant information, in addition to the request for non-overlapping SRS resources. In such examples, the nonCriticalExtension field of the UAI may be reserved for use by the multi-subscription UE. For example, the UE may request the non-overlapping SRS resources by indicating a preferred SRS time slot via transmission of the preferred SRS periodicity and offset (e.g., SRS-PeriodicityAndOffset) for each SRS used for antennaSwitching. In such cases, the UE may format the UAI message to indicate the SRS periodicity and offset, for example:

```
UEAssistanceInformation-v1540-Ies->nonCriticalExtension
{
  preferredSRSTimedomain SRS-PreferenceList
}
SRS-PreferenceList SEQUENCE (SIZE(1..maxNrofSRS-Resources)) OF SRS-
Preference
SRS-preference SEQUENCE {
    srs-ResourceId SRS-ResourceId ,
    periodicityAndOffset SRS-PeriodicityAndOffset
}
```

In some examples, the UE may have 2T4R capabilities, and the network may configure two SRS resources for antenna switching for transmission of SRS from the UE, which may be at least partially overlapped in the time domain. For example, the network may indicate the following SRS resource configurations shown in Table 1:

TABLE 1
SRS Resource Allocation 1

| Sub1 SRS Resources for 2T4R | | Sub2 SRS Resources for 2T4R | |
|---|---|---|---|
| Antenna Switching | | Antenna Switching | |
| srs-ResourceId 1 | srs-ResourceId 2 | srs-ResourceId 1 | srs-ResourceId 2 |
| periodicityAndOffset-p | periodicityAndOffset-p | periodicityAndOffset-p | periodicityAndOffset-p |
| s180: 7 | s180: 47 | s180: 7 | s180: 47 |

In such examples, the first subscription of the UE may transmit UAI to request an offset of 17 and 57 for SRS resources in order to obtain non-overlapping resources with the second subscription in the time domain. For example, the first subscription may transmit the following UAI:

```
UEAssistanceInformation-v1540-Ies->nonCriticalExtension . . .
  preferredSRSTimedomain
  { srs-ResourceId 1,
    periodicityAndOffset sl80: 17 . . .
  { srs-ResourceId 2,
    periodicityAndOffset sl80: 57 . . . }.
```

In some other examples, the network may configure two SRS resources for antenna switching for transmission of SRS from the UE, which may be at least partially overlapped in the time domain. For example, the network may indicate the following SRS resource configurations shown in Table 2:

TABLE 2
SRS Resource Allocation 2

| Sub1 SRS Resources for 2T4R | | Sub2 SRS Resources for 2T4R | |
|---|---|---|---|
| Antenna Switching | | Antenna Switching | |
| srs-ResourceId 1 | srs-ResourceId 2 | srs-ResourceId 1 | srs-ResourceId 2 |
| periodicityAndOffset-p | periodicityAndOffset-p | periodicityAndOffset-p | periodicityAndOffset-p |
| s120: 7 | s120: 17 | s180: 27 | s180: 47 |

In such examples, the first subscription of the UE may transmit UAI to request a periodicity of 80 slots in order to obtain non-overlapping resources with the second subscription in the time domain. For example, the first subscription may transmit the following UAI:

```
UEAssistanceInformation-v1540-Ies->nonCriticalExtension . . .
  preferredSRSTimedomain
  { srs-ResourceId 1,
      periodicityAndOffset sl80: 7 . . .
  { srs-ResourceId 2,
    periodicityAndOffset sl80: 17 . . . }
```

At 620, the network may reconfigure the SRS resources such that the SRS is non-overlapping in the time domain. In some examples, the network may reconfigured the SRS resources based on receiving the UAI message from the UE.

At 625, the UE may transmit SRS associated with Sub1 and Sub2 that are multiplexed in time.

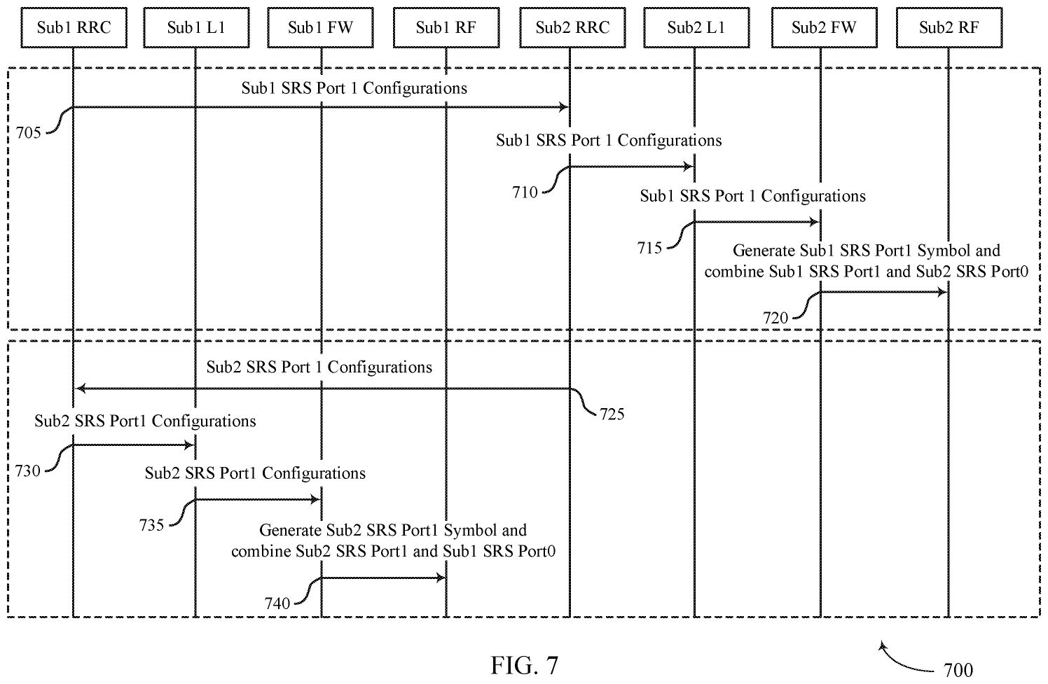

FIG. 7 illustrates an example of a process flow 700 that supports uplink multiplexing and antenna port mapping for multiple subscriptions in accordance with one or more aspects of the present disclosure. In some examples, process flow 700 may implement aspects of wireless communications system 100. The process flow 700 may be performed at or by a UE, which may each be an example of a UE 115 as described herein. Alternative examples of the following process flow may be implemented, where some steps are performed in a different order than described or are not performed at all. In some cases, steps may include additional features not mentioned below, or further steps may be added.

Process flow 700 may illustrate a call flow at a UE supporting DSDA capabilities having two or more connected subscriptions, and may illustrate a flow between RRC components (e.g., Sub1 RRC, Sub2 RRC), layer-1 components (Sub1 L1, Sub2 L1), firmware components (e.g., Sub1 FW, Sub2 FW), and RF components (e.g., Sub1 RF, Sub2 RF) of the DSDA UE.

At 705, the Sub1 RRC may send SRS port 1 configuration information to the Sub 2 RRC. At 710, the Sub2 RRC may forward the SRS port 1 configuration information to the Sub2 L1. At 715, the Sub2 L1 may forward the SRS Port 1 configuration information to the Sub2 FW. Then, at 720, the Sub2 FW may forward the SRS Port 1 configuration information to the Sub2 RF, and the Sub2 RF may generate a SRS Port 1 symbol for Sub1, and may combine the Sub1 SRS port 1 with the Sub2 SRS Port 0.

Similarly, at 725, the Sub2 RRC may send SRS port 1 configuration information to the Sub 1 RRC. At 730, the Sub1 RRC may forward the SRS port 1 configuration information to the Sub1 L1. At 735, the Sub1 L1 may forward the SRS Port 1 configuration information to the Sub1 FW. Then, at 740, the Sub1 FW may forward the SRS Port 1 configuration information to the Sub1 RF, and the Sub1 RF may generate a SRS Port 1 symbol for Sub2, and may combine the Sub2 SRS port 1 with the Sub1 SRS Port 0. In such cases, the UE may share Port 1 and Port 0 for the SRS of each subscription.

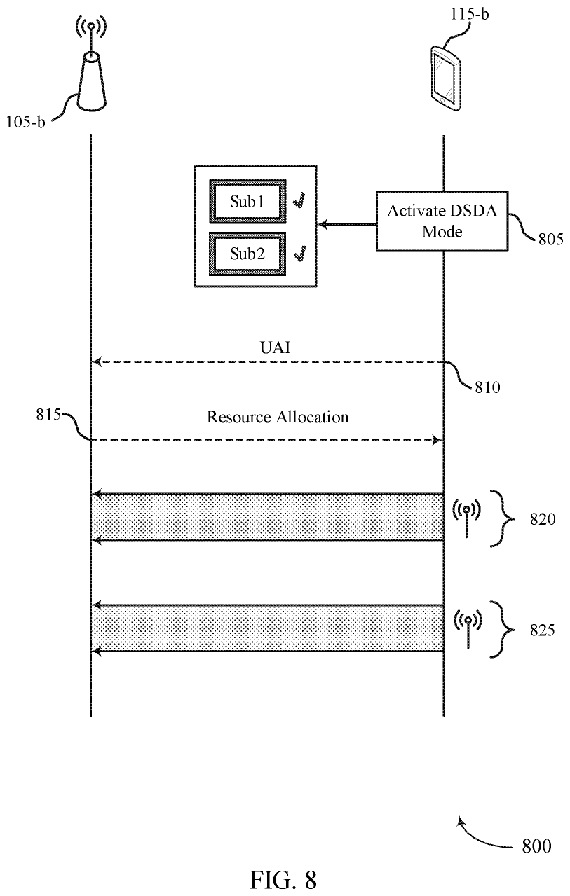

FIG. 8 illustrates an example of a process flow 800 that supports uplink multiplexing and antenna port mapping for multiple subscriptions in accordance with one or more aspects of the present disclosure. In some examples, process flow 800 may implement aspects of wireless communications system 100. The process flow 800 may include UE 115-b, which may each be an example of a UE 115 as described herein. The process flow 800 may also include a network entity 105-b, which may each be an example of a network entity as described herein. Alternative examples of the following process flow may be implemented, where some steps are performed in a different order than described or are not performed at all. In some cases, steps may include additional features not mentioned below, or further steps may be added.

At 805, the UE 115-b may activate a dual-subscriber dual-active mode to communicate using at least two subscriptions of the UE 115-b (e.g., Sub1 and Sub2) via one or more antenna ports. In some examples, the activated dual-subscriber dual-active mode may be an activated UE capability.

At 810, the UE 115-b may transmit a UAI message that includes a request for an allocation of a set of time-frequency resources that are non-overlapping in time. In some cases, the UE 115-b may form at the request in a field of the UAI message, such as in a non-critical extension field of the UAI message. In some examples, the UAI message may also include a preferred time slot for transmission of a first uplink signal and a second uplink signal, a periodicity for transmission of the first uplink signal and the second uplink signal, an offset for transmission of the first uplink signal and the second uplink signal, an indication of a change of the set of time-frequency resources to a different set of time-frequency resources, or any combination thereof.

At 815, the UE 115-b may in some examples receive a resource allocation message that indicates a first set of time resources, a first set of frequency resources, or both, that are non-overlapping in time (e.g., in response to the transmitted UAI message). The UE 115-b may use the non-overlapping resources for transmission of the first uplink signal associated with the first subscription and the second signal associated with the second subscription. In some examples, the UE 115-b may receive a control information message from the network entity 105-b that includes a listing of non-overlapping time-frequency resources to use for transmission of the first uplink signal associated with a first subscription and for transmission of the second uplink signal associated with the second subscription. In some cases, the listing of time-frequency resources are non-overlapping based on a slot offset of the non-overlapping time-frequency resources, a periodicity of the non-overlapping time-frequency resources, or both.

At 820, the UE 115-b may transmit, via a first antenna port and using a set of time-frequency resources, the first uplink signal (e.g., a first SRS) associated with a first subscription (e.g., Sub1) of the at least two subscriptions of the UE 115-b. In some examples, the first uplink signal may be multiplexed with the second uplink signal (e.g., a second SRS) associated with a second subscription (e.g., Sub2) based on the activation of the dual-subscriber dual-active mode.

In some examples, the UE 115-b may transmit the first uplink signal associated with the first subscription and the second uplink signal associated with the second subscription via the first antenna port and the second antenna port using a first set of time resources. For example, the first uplink signal may be multiplexed in time with the second uplink signal and transmitted by the first antenna port and the second antenna port.

At 825, the UE 115-b may transmit, via a second antenna port and using the set of time-frequency resources, the first uplink signal (e.g., the first SRS) associated with the first subscription (e.g., Sub1) of the at least two subscriptions of the UE 115-b. In some examples, the first uplink signal may be multiplexed with the second uplink signal (e.g., a second SRS) associated with a second subscription (e.g., Sub2) at the second antenna port based on the activation of the dual-subscriber dual-active mode.

In some examples, the UE 115-b may transmit the first uplink signal associated with the first subscription and the second uplink signal associated with the second subscription via the first antenna port and the second antenna port using a first set of frequency resources. For example, the first uplink signal may be multiplexed in frequency with the second uplink signal and transmitted by the first antenna port and the second antenna port. In some examples, the first antenna port is associated with the first subscription and the second antenna port is associated with the second subscription.

In some examples, the UE 115-b may receive an indication of the set of time-frequency resources that further indicates resources allocated for switching between the first antenna port and the second antenna port, for example, in cases where the set of time-frequency resources associated with the first subscription and the second subscription at least partially overlap in time. In such cases, the UE 115-b may receive an updated set of time-frequency resources that are non-overlapping in time (e.g., based on transmission of the UAI message).

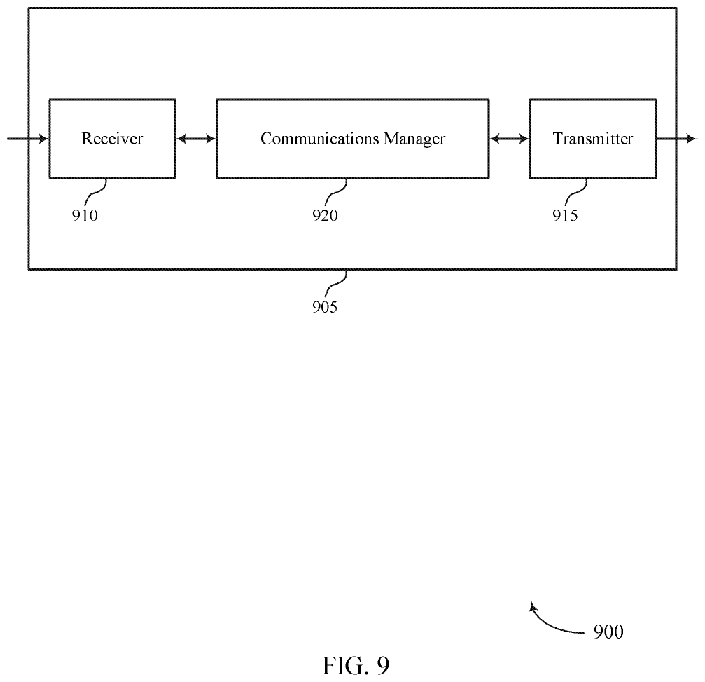

FIG. 9 shows a block diagram 900 of a device 905 that supports uplink multiplexing and antenna port mapping for multiple subscriptions in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to uplink multiplexing and antenna port mapping for multiple subscriptions). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to uplink multiplexing and antenna port mapping for multiple subscriptions). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of uplink multiplexing and antenna port mapping for multiple subscriptions as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. For example, the communications manager 920 may be configured as or otherwise support a means for activating a dual-subscriber dual-active mode for the UE to communicate using at least two subscriptions of the UE via one or more antenna ports of the UE. The communications manager 920 may be configured as or otherwise support a means for transmitting, via a first antenna port of the one or more antenna ports of the UE and using a set of time-frequency resources, a first uplink signal associated with a first subscription of the at least two subscriptions multiplexed with a second uplink signal associated with a second subscription of the at least two subscriptions based on activation of the dual-subscriber dual-active mode. The communications manager 920 may be configured as or otherwise support a means for transmitting, via a second antenna port of the one or more antenna ports of the UE and using the set of time-frequency resources, the first uplink signal associated with the first subscription of the at least two subscriptions multiplexed with the second uplink signal associated with the second subscription of the at least two subscriptions of the UE based on activation of the dual-subscriber dual-active mode.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources, enhanced channel sounding procedures, more efficient and accurate precoding estimation, optimized performance between multiple subscriptions of a device, and more efficient resource allocation.

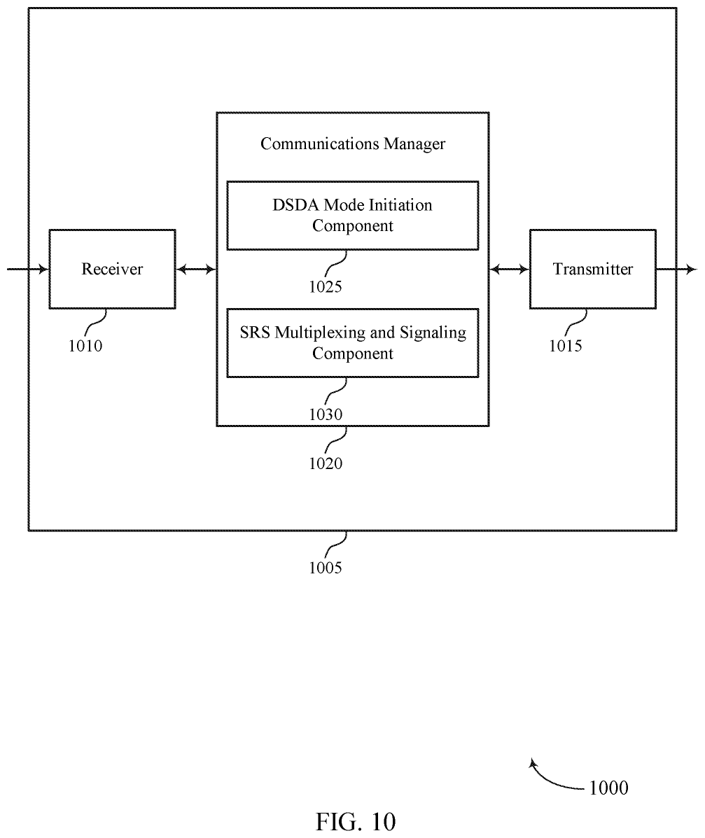

FIG. 10 shows a block diagram 1000 of a device 1005 that supports uplink multiplexing and antenna port mapping for multiple subscriptions in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to uplink multiplexing and antenna port mapping for multiple subscriptions). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to uplink multiplexing and antenna port mapping for multiple subscriptions). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of uplink multiplexing and antenna port mapping for multiple subscriptions as described herein. For example, the communications manager 1020 may include a DSDA mode initiation component 1025 an SRS multiplexing and signaling component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a UE in accordance with examples as disclosed herein. The DSDA mode initiation component 1025 may be configured as or otherwise support a means for activating a dual-subscriber dual-active mode for the UE to communicate using at least two subscriptions of the UE via one or more antenna ports of the UE. The SRS multiplexing and signaling component 1030 may be configured as or otherwise support a means for transmitting, via a first antenna port of the one or more antenna ports of the UE and using a set of time-frequency resources, a first uplink signal associated with a first subscription of the at least two subscriptions multiplexed with a second uplink signal associated with a second subscription of the at least two subscriptions based on activation of the dual-subscriber dual-active mode. The SRS multiplexing and signaling component 1030 may be configured as or otherwise support a means for transmitting, via a second antenna port of the one or more antenna ports of the UE and using the set of time-frequency resources, the first uplink signal associated with the first subscription of the at least two subscriptions multiplexed with the second uplink signal associated with the second subscription of the at least two subscriptions of the UE based on activation of the dual-subscriber dual-active mode.

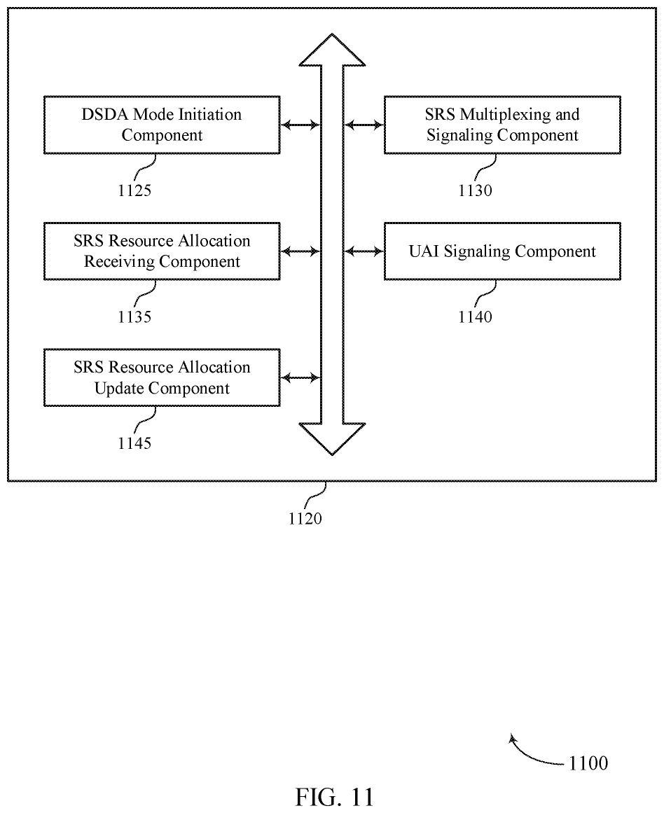

FIG. 11 shows a block diagram 1100 of a communications manager 1120 that supports uplink multiplexing and antenna port mapping for multiple subscriptions in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of uplink multiplexing and antenna port mapping for multiple subscriptions as described herein. For example, the communications manager 1120 may include a DSDA mode initiation component 1125, an SRS multiplexing and signaling component 1130, an SRS resource allocation receiving component 1135, a UAI signaling component 1140, an SRS resource allocation update component 1145, or any combination thereof. Each of these components may communicate, directly or indirectly, with one another (e.g., via one or more buses).

The communications manager 1120 may support wireless communications at a UE in accordance with examples as disclosed herein. The DSDA mode initiation component 1125 may be configured as or otherwise support a means for activating a dual-subscriber dual-active mode for the UE to communicate using at least two subscriptions of the UE via one or more antenna ports of the UE. The SRS multiplexing and signaling component 1130 may be configured as or otherwise support a means for transmitting, via a first antenna port of the one or more antenna ports of the UE and using a set of time-frequency resources, a first uplink signal associated with a first subscription of the at least two subscriptions multiplexed with a second uplink signal associated with a second subscription of the at least two subscriptions based on activation of the dual-subscriber dual-active mode. In some examples, the SRS multiplexing and signaling component 1130 may be configured as or otherwise support a means for transmitting, via a second antenna port of the one or more antenna ports of the UE and using the set of time-frequency resources, the first uplink signal associated with the first subscription of the at least two subscriptions multiplexed with the second uplink signal associated with the second subscription of the at least two subscriptions of the UE based on activation of the dual-subscriber dual-active mode.

In some examples, the SRS multiplexing and signaling component 1130 may be configured as or otherwise support a means for transmitting, via the first antenna port of the one or more antenna ports of the UE and using a first set of time resources of the set of time-frequency resources, the first uplink signal associated with the first subscription multiplexed in time with the second uplink signal associated with the second subscription. In some examples, the SRS multiplexing and signaling component 1130 may be configured as or otherwise support a means for transmitting, via the second antenna port of the one or more antenna ports of the UE and using a second set of time resources of the set of time-frequency resources, the first uplink signal associated with the first subscription multiplexed in time with the second uplink signal associated with the second subscription.

In some examples, the SRS resource allocation receiving component 1135 may be configured as or otherwise support a means for receiving a resource allocation message indicating the first set of time resources and the second set of time resources, where the first set of time resources and the second set of time resources are non-overlapping in time.

In some examples, the SRS multiplexing and signaling component 1130 may be configured as or otherwise support a means for transmitting, via the first antenna port of the one or more antenna ports of the UE and using a first set of frequency resources of the set of time-frequency resources, the first uplink signal associated with the first subscription multiplexed in frequency with the second uplink signal associated with the second subscription. In some examples, the SRS resource allocation receiving component 1135 may be configured as or otherwise support a means for transmitting, via the second antenna port of the one or more antenna ports of the UE and using a second set of frequency resources of the set of time-frequency resources, the first uplink signal associated with the first subscription multiplexed in frequency with the second uplink signal associated with the second subscription.

In some examples, the SRS resource allocation receiving component 1135 may be configured as or otherwise support a means for receiving a resource allocation message indicating the first set of frequency resources and the second set of frequency resources, where the first set of frequency resources and the second set of frequency resources are non-overlapping in frequency.

In some examples, the UAI signaling component 1140 may be configured as or otherwise support a means for transmitting a UAI message that includes a request for allocating the set of time-frequency resources that are non-overlapping in time. In some examples, the SRS multiplexing and signaling component 1130 may be configured as or otherwise support a means for transmitting the first uplink signal associated with the first subscription and the second uplink signal associated with the second subscription via the first antenna port and the second antenna port of the one or more antenna ports of the UE using the set of time-frequency resources that are non-overlapping in time based on the UAI message.

In some examples, the UAI signaling component 1140 may be configured as or otherwise support a means for transmitting the request for allocating the set of time-frequency resources in at least one field of the UAI message.

In some examples, the at least one field of the UAI message includes a non-critical extension field.

In some examples, the UAI message further includes a preferred time slot for transmission of the first uplink signal and the second uplink signal, a periodicity for transmission of the first uplink signal and the second uplink signal, an offset for transmission of the first uplink signal and the second uplink signal, an indication of a change of the set of time-frequency resources to a different set of time-frequency resources, or any combination thereof.

In some examples, the SRS resource allocation receiving component 1135 may be configured as or otherwise support a means for receiving an indication of the set of time-frequency resources that further indicates resources allocated for switching between the first antenna port and the second antenna port of the one or more antenna ports of the UE, the set of time-frequency resources associated with the first subscription and the second subscription at least partially overlapping in time. In some examples, the UAI signaling component 1140 may be configured as or otherwise support a means for transmitting the UAI message that includes the request for allocating the set of time-frequency resources that are non-overlapping in time based on the indication.

In some examples, the SRS resource allocation update component 1145 may be configured as or otherwise support a means for receiving an updated set of time-frequency resources that are non-overlapping in time based on the UAI message.

In some examples, the SRS resource allocation receiving component 1135 may be configured as or otherwise support a means for receiving a control information message that includes a listing of time-frequency resources including the set of time-frequency resources, where the listing of time-frequency resources are non-overlapping time-frequency resources to use for transmission of the first uplink signal associated with a first subscription and for transmission of the second uplink signal associated with the second subscription.

In some examples, the listing of time-frequency resources are non-overlapping based on slot offset of the non-overlapping time-frequency resources, periodicity of the non-overlapping time-frequency resources, or both.

In some examples, the first antenna port is associated with the first subscription and the second antenna port is associated with the second subscription.

In some examples, the dual-subscriber dual-active mode is associated with an activated UE capability.

In some examples, the first uplink signal and the second uplink signal include one or more sounding reference signals.

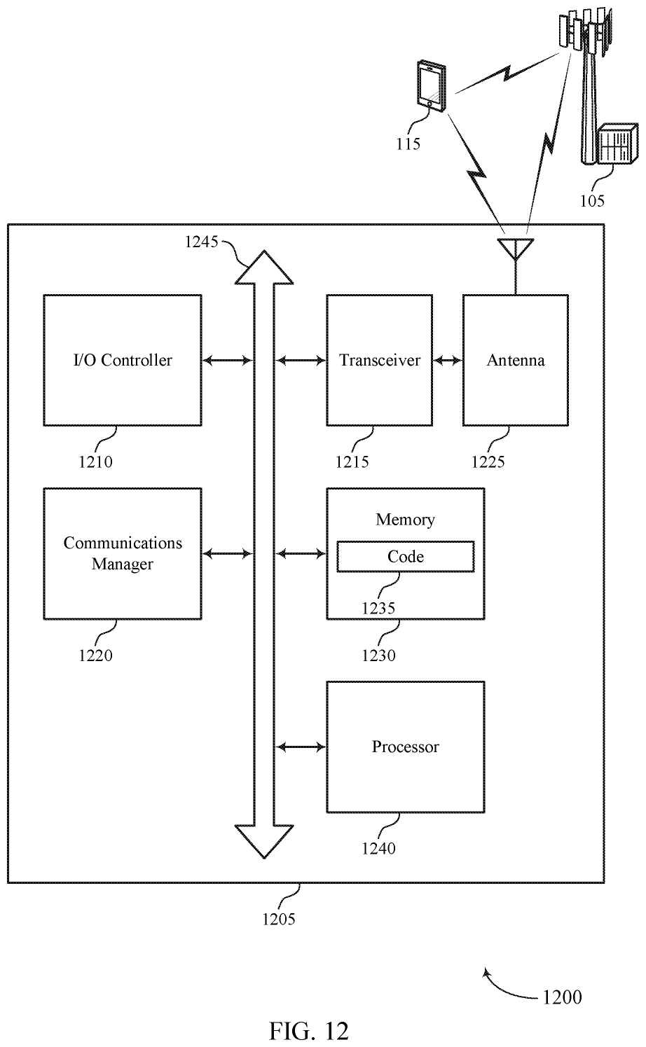

FIG. 12 shows a diagram of a system 1200 including a device 1205 that supports uplink multiplexing and antenna port mapping for multiple subscriptions in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting uplink multiplexing and antenna port mapping for multiple subscriptions). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communications at a UE in accordance with examples as disclosed herein. For example, the communications manager 1220 may be configured as or otherwise support a means for activating a dual-subscriber dual-active mode for the UE to communicate using at least two subscriptions of the UE via one or more antenna ports of the UE. The communications manager 1220 may be configured as or otherwise support a means for transmitting, via a first antenna port of the one or more antenna ports of the UE and using a set of time-frequency resources, a first uplink signal associated with a first subscription of the at least two subscriptions multiplexed with a second uplink signal associated with a second subscription of the at least two subscriptions based on activation of the dual-subscriber dual-active mode. The communications manager 1220 may be configured as or otherwise support a means for transmitting, via a second antenna port of the one or more antenna ports of the UE and using the set of time-frequency resources, the first uplink signal associated with the first subscription of the at least two subscriptions multiplexed with the second uplink signal associated with the second subscription of the at least two subscriptions of the UE based on activation of the dual-subscriber dual-active mode.

By including or configuring the communications manager 1220 in accordance with examples as described herein, the device 1205 may support techniques for improved communication reliability, more efficient utilization of communication resources, improved coordination between devices, enhanced channel sounding procedures (e.g., more complete or accurate channel sounding), more efficient and accurate precoding estimation (e.g., precoding matrix estimation), optimized performance between multiple subscriptions of a device, and more efficient resource allocation.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of uplink multiplexing and antenna port mapping for multiple subscriptions as described herein, or the processor 1240 and the memory 1230 may be otherwise configured to perform or support such operations.

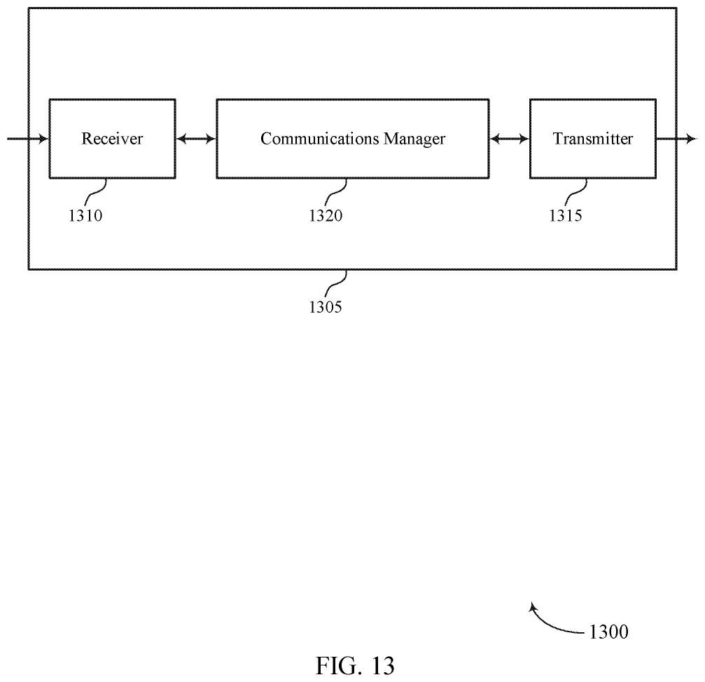

FIG. 13 shows a block diagram 1300 of a device 1305 that supports uplink multiplexing and antenna port mapping for multiple subscriptions in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of uplink multiplexing and antenna port mapping for multiple subscriptions as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a network entity in accordance with examples as disclosed herein. For example, the communications manager 1320 may be configured as or otherwise support a means for receiving, from a UE, a UAI message that includes a request for allocating a set of time-frequency resources that are non-overlapping in time, frequency, or both. The communications manager 1320 may be configured as or otherwise support a means for receiving, via the set of time-frequency resources, a first uplink signal associated with a first subscription of the UE multiplexed with a second uplink signal associated with a second subscription of the UE.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for more efficient utilization of communication resources, enhanced channel sounding procedures, more efficient and accurate precoding estimation, optimized performance between multiple subscriptions of a device, and more efficient resource allocation.

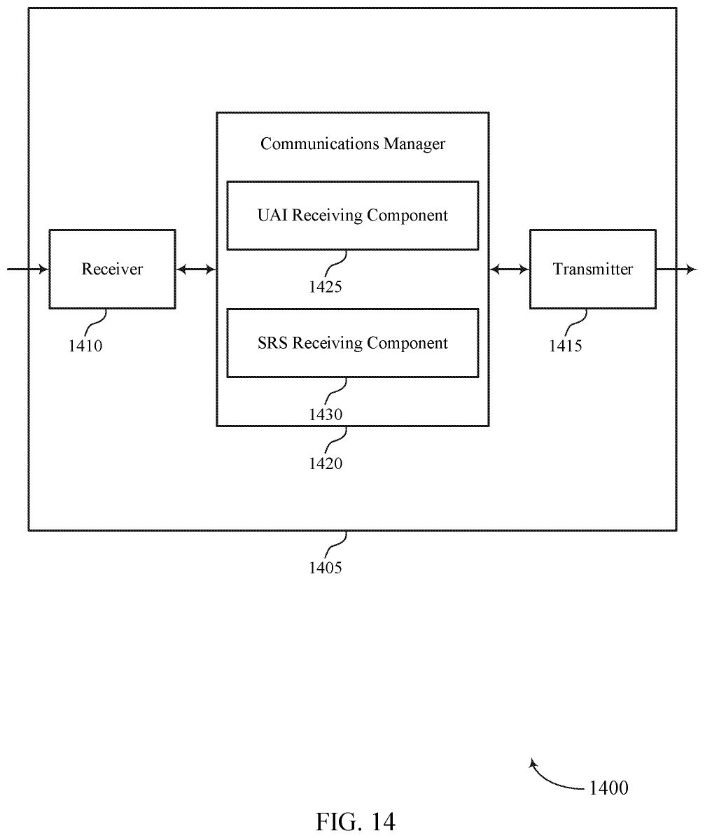

FIG. 14 shows a block diagram 1400 of a device 1405 that supports uplink multiplexing and antenna port mapping for multiple subscriptions in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of uplink multiplexing and antenna port mapping for multiple subscriptions as described herein. For example, the communications manager 1420 may include a UAI receiving component 1425 an SRS receiving component 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications at a network entity in accordance with examples as disclosed herein. The UAI receiving component 1425 may be configured as or otherwise support a means for receiving, from a UE, a UAI message that includes a request for allocating a set of time-frequency resources that are non-overlapping in time, frequency, or both. The SRS receiving component 1430 may be configured as or otherwise support a means for receiving, via the set of time-frequency resources, a first uplink signal associated with a first subscription of the UE multiplexed with a second uplink signal associated with a second subscription of the UE.

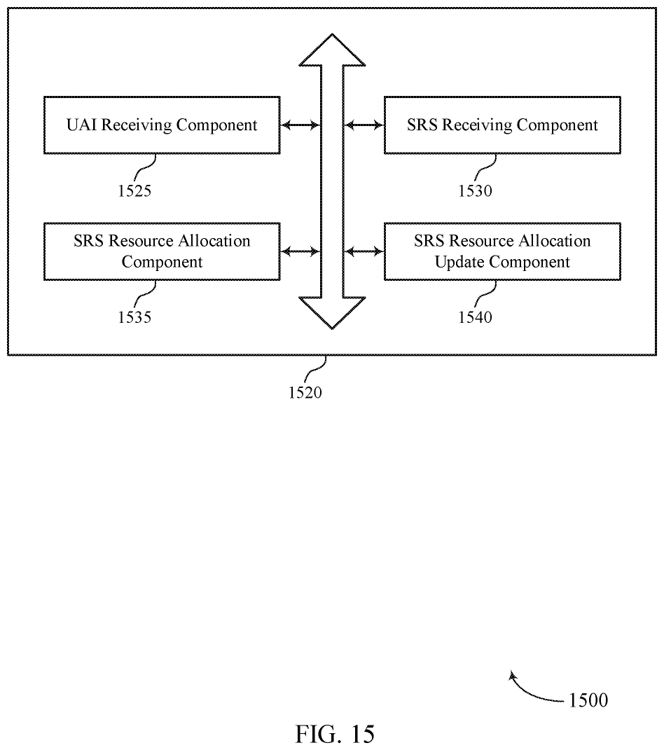

FIG. 15 shows a block diagram 1500 of a communications manager 1520 that supports uplink multiplexing and antenna port mapping for multiple subscriptions in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of uplink multiplexing and antenna port mapping for multiple subscriptions as described herein. For example, the communications manager 1520 may include a UAI receiving component 1525, an SRS receiving component 1530, an SRS resource allocation component 1535, an SRS resource allocation update component 1540, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications at a network entity in accordance with examples as disclosed herein. The UAI receiving component 1525 may be configured as or otherwise support a means for receiving, from a UE, a UAI message that includes a request for allocating a set of time-frequency resources that are non-overlapping in time, frequency, or both. The SRS receiving component 1530 may be configured as or otherwise support a means for receiving, via the set of time-frequency resources, a first uplink signal associated with a first subscription of the UE multiplexed with a second uplink signal associated with a second subscription of the UE.

In some examples, the SRS receiving component 1530 may be configured as or otherwise support a means for receiving, via a first set of time resources of the set of time-frequency resources, the first uplink signal associated with the first subscription multiplexed in time with the second uplink signal associated with the second subscription. In some examples, the SRS receiving component 1530 may be configured as or otherwise support a means for receiving, via a second set of time resources of the set of time-frequency resources, the first uplink signal associated with the first subscription multiplexed in time with the second uplink signal associated with the second subscription.

In some examples, the SRS resource allocation component 1535 may be configured as or otherwise support a means for transmitting a resource allocation message indicating the first set of time resources and the second set of time resources, where the first set of time resources and the second set of time resources are non-overlapping in time.

In some examples, the SRS receiving component 1530 may be configured as or otherwise support a means for receiving, via a first set of frequency resources of the set of time-frequency resources, the first uplink signal associated with the first subscription multiplexed in frequency with the second uplink signal associated with the second subscription. In some examples, the SRS receiving component 1530 may be configured as or otherwise support a means for receiving, via a second set of frequency resources of the set of time-frequency resources, the first uplink signal associated with the first subscription multiplexed in frequency with the second uplink signal associated with the second subscription.

In some examples, the SRS resource allocation component 1535 may be configured as or otherwise support a means for transmitting a resource allocation message indicating the first set of frequency resources and the second set of frequency resources, where the first set of frequency resources and the second set of frequency resources are non-overlapping in frequency.

In some examples, the UAI receiving component 1525 may be configured as or otherwise support a means for receiving the request for allocating the set of time-frequency resources in at least one field of the UAI message, where the at least one field of the UAI message includes a non-critical extension field.

In some examples, the UAI message further includes a preferred time slot for transmission of the first uplink signal and the second uplink signal, a periodicity for transmission of the first uplink signal and the second uplink signal, and offset for transmission of the first uplink signal and the second uplink signal, an indication of a change of the set of time-frequency resources to a different set of time-frequency resources, or any combination thereof.

In some examples, the SRS resource allocation component 1535 may be configured as or otherwise support a means for transmitting an indication of the set of time-frequency resources that further indicates resources allocated for switching between a first antenna port and a second antenna port of one or more antenna ports of the UE, the set of time-frequency resources associated with the first subscription and the second subscription at least partially overlapping in time. In some examples, the UAI receiving component 1525 may be configured as or otherwise support a means for receiving the UAI message that includes the request for allocating the set of time-frequency resources that are non-overlapping in time based on the indication.

In some examples, the SRS resource allocation update component 1540 may be configured as or otherwise support a means for transmitting an updated set of time-frequency resources that are non-overlapping in time based on the UAI message.

In some examples, the SRS resource allocation component 1535 may be configured as or otherwise support a means for transmitting a control information message that includes a listing of time-frequency resources including the set of time-frequency resources, where the listing of time-frequency resources are non-overlapping time-frequency resources to use for transmission of the first uplink signal associated with a first subscription and for transmission of the second uplink signal associated with the second subscription.

In some examples, the listing of time-frequency resources are non-overlapping based on slot offset of the non-overlapping time-frequency resources, periodicity of the non-overlapping time-frequency resources, or both.

In some examples, the first uplink signal and the second uplink signal include one or more sounding reference signals.

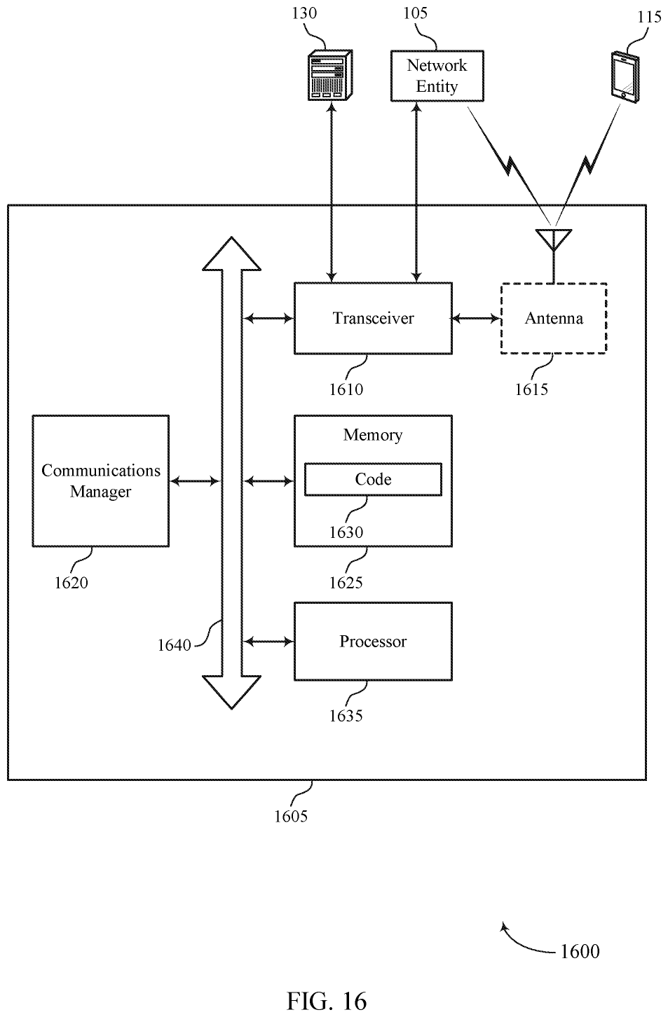

FIG. 16 shows a diagram of a system 1600 including a device 1605 that supports uplink multiplexing and antenna port mapping for multiple subscriptions in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or memory components (for example, the processor 1635, or the memory 1625, or both), may be included in a chip or chip assembly that is installed in the device 1605. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting uplink multiplexing and antenna port mapping for multiple subscriptions). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605. The processor 1635 may be any one or more suitable processors capable of executing scripts or instructions of one or more software programs stored in the device 1605 (such as within the memory 1625). In some implementations, the processor 1635 may be a component of a processing system. A processing system may generally refer to a system or series of machines or components that receives inputs and processes the inputs to produce a set of outputs (which may be passed to other systems or components of, for example, the device 1605). For example, a processing system of the device 1605 may refer to a system including the various other components or subcomponents of the device 1605, such as the processor 1635, or the transceiver 1610, or the communications manager 1620, or other components or combinations of components of the device 1605. The processing system of the device 1605 may interface with other components of the device 1605, and may process information received from other components (such as inputs or signals) or output information to other components. For example, a chip or modem of the device 1605 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1605 may transmit information output from the chip or modem. Additionally, or alternatively, in some implementations, the one or more interfaces may refer to an interface between the processing system of the chip or modem and a receiver, such that the device 1605 may obtain information or signal inputs, and the information may be passed to the processing system. A person having ordinary skill in the art will readily recognize that a first interface also may obtain information or signal inputs, and a second interface also may output information or signal outputs.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communications at a network entity in accordance with examples as disclosed herein. For example, the communications manager 1620 may be configured as or otherwise support a means for receiving, from a UE, a UAI message that includes a request for allocating a set of time-frequency resources that are non-overlapping in time, frequency, or both. The communications manager 1620 may be configured as or otherwise support a means for receiving, via the set of time-frequency resources, a first uplink signal associated with a first subscription of the UE multiplexed with a second uplink signal associated with a second subscription of the UE.

By including or configuring the communications manager 1620 in accordance with examples as described herein, the device 1605 may support techniques for improved communication reliability, more efficient utilization of communication resources, improved coordination between devices, enhanced channel sounding procedures (e.g., more complete or accurate channel sounding), more efficient and accurate precoding estimation (e.g., precoding matrix estimation), optimized performance between multiple subscriptions of a device, and more efficient resource allocation.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, the processor 1635, the memory 1625, the code 1630, or any combination thereof. For example, the code 1630 may include instructions executable by the processor 1635 to cause the device 1605 to perform various aspects of uplink multiplexing and antenna port mapping for multiple subscriptions as described herein, or the processor 1635 and the memory 1625 may be otherwise configured to perform or support such operations.

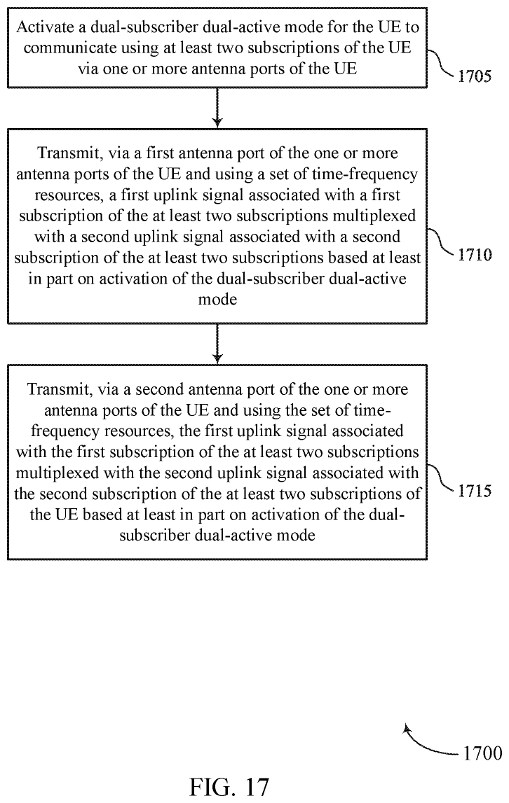

FIG. 17 shows a flowchart illustrating a method 1700 that supports uplink multiplexing and antenna port mapping for multiple subscriptions in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include activating a dual-subscriber dual-active mode for the UE to communicate using at least two subscriptions of the UE via one or more antenna ports of the UE. The operations of 1705 may be performed in accordance with examples as disclosed herein. In some examples, aspects of the operations of 1705 may be performed by a DSDA mode initiation component 1125 as described with reference to FIG. 11.

At 1710, the method may include transmitting, via a first antenna port of the one or more antenna ports of the UE and using a set of time-frequency resources, a first uplink signal associated with a first subscription of the at least two subscriptions multiplexed with a second uplink signal associated with a second subscription of the at least two subscriptions based on activation of the dual-subscriber dual-active mode. The operations of 1710 may be performed in accordance with examples as disclosed herein. In some examples, aspects of the operations of 1710 may be performed by an SRS multiplexing and signaling component 1130 as described with reference to FIG. 11.

At 1715, the method may include transmitting, via a second antenna port of the one or more antenna ports of the UE and using the set of time-frequency resources, the first uplink signal associated with the first subscription of the at least two subscriptions multiplexed with the second uplink signal associated with the second subscription of the at least two subscriptions of the UE based on activation of the dual-subscriber dual-active mode. The operations of 1715 may be performed in accordance with examples as disclosed herein. In some examples, aspects of the operations of 1715 may be performed by an SRS multiplexing and signaling component 1130 as described with reference to FIG. 11.

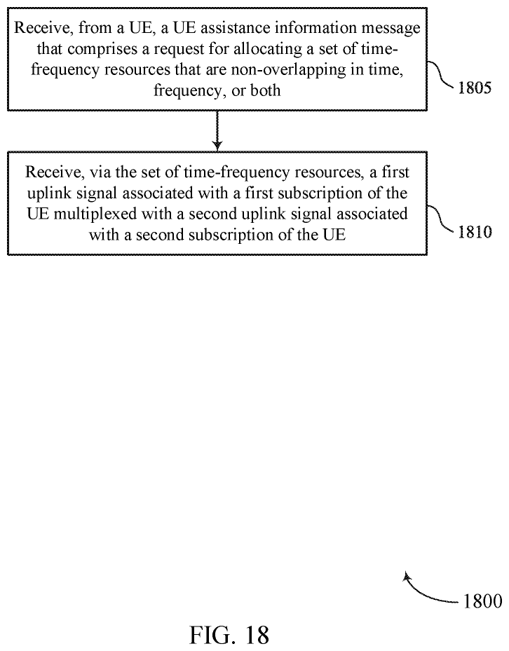

FIG. 18 shows a flowchart illustrating a method 1800 that supports uplink multiplexing and antenna port mapping for multiple subscriptions in accordance with one or more aspects of the present disclosure. The operations of the method 1800 may be implemented by a network entity or its components as described herein. For example, the operations of the method 1800 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1805, the method may include receiving, from a UE, a UAI message that includes a request for allocating a set of time-frequency resources that are non-overlapping in time, frequency, or both. The operations of 1805 may be performed in accordance with examples as disclosed herein. In some examples, aspects of the operations of 1805 may be performed by a UAI receiving component 1525 as described with reference to FIG. 15.

At 1810, the method may include receiving, via the set of time-frequency resources, a first uplink signal associated with a first subscription of the UE multiplexed with a second uplink signal associated with a second subscription of the UE. The operations of 1810 may be performed in accordance with examples as disclosed herein. In some examples, aspects of the operations of 1810 may be performed by an SRS receiving component 1530 as described with reference to FIG. 15.

The following provides an overview of aspects of the present disclosure:

Aspect 1: A method for wireless communications at a UE, comprising: activating a dual-subscriber dual-active mode for the UE to communicate using at least two subscriptions of the UE via one or more antenna ports of the UE; transmitting, via a first antenna port of the one or more antenna ports of the UE and using a set of time-frequency resources, a first uplink signal associated with a first subscription of the at least two subscriptions multiplexed with a second uplink signal associated with a second subscription of the at least two subscriptions based at least in part on activation of the dual-subscriber dual-active mode; and transmitting, via a second antenna port of the one or more antenna ports of the UE and using the set of time-frequency resources, the first uplink signal associated with the first subscription of the at least two subscriptions multiplexed with the second uplink signal associated with the second subscription of the at least two subscriptions of the UE based at least in part on activation of the dual-subscriber dual-active mode.

Aspect 2: The method of aspect 1, further comprising: transmitting, via the first antenna port of the one or more antenna ports of the UE and using a first set of time resources of the set of time-frequency resources, the first uplink signal associated with the first subscription multiplexed in time with the second uplink signal associated with the second subscription; and transmitting, via the second antenna port of the one or more antenna ports of the UE and using a second set of time resources of the set of time-frequency resources, the first uplink signal associated with the first subscription multiplexed in time with the second uplink signal associated with the second subscription.

Aspect 3: The method of aspect 2, further comprising: receiving a resource allocation message indicating the first set of time resources and the second set of time resources, wherein the first set of time resources and the second set of time resources are non-overlapping in time.

Aspect 4: The method of any of aspects 1 through 3, further comprising: transmitting, via the first antenna port of the one or more antenna ports of the UE and using a first set of frequency resources of the set of time-frequency resources, the first uplink signal associated with the first subscription multiplexed in frequency with the second uplink signal associated with the second subscription; and transmitting, via the second antenna port of the one or more antenna ports of the UE and using a second set of frequency resources of the set of time-frequency resources, the first uplink signal associated with the first subscription multiplexed in frequency with the second uplink signal associated with the second subscription.

Aspect 5: The method of aspect 4, further comprising: receiving a resource allocation message indicating the first set of frequency resources and the second set of frequency resources, wherein the first set of frequency resources and the second set of frequency resources are non-overlapping in frequency.

Aspect 6: The method of any of aspects 1 through 5, further comprising: transmitting a UAI message that comprises a request for allocating the set of time-frequency resources that are non-overlapping in time; and transmitting the first uplink signal associated with the first subscription and the second uplink signal associated with the second subscription via the first antenna port and the second antenna port of the one or more antenna ports of the UE using the set of time-frequency resources that are non-overlapping in time based at least in part on the UAI message.

Aspect 7: The method of aspect 6, further comprising: transmitting the request for allocating the set of time-frequency resources in at least one field of the UAI message.

Aspect 8: The method of aspect 7, wherein the at least one field of the UAI message comprises a non-critical extension field.

Aspect 9: The method of any of aspects 6 through 8, wherein the UAI message further comprises a preferred time slot for transmission of the first uplink signal and the second uplink signal, a periodicity for transmission of the first uplink signal and the second uplink signal, an offset for transmission of the first uplink signal and the second uplink signal, an indication of a change of the set of time-frequency resources to a different set of time-frequency resources, or any combination thereof.

Aspect 10: The method of any of aspects 6 through 9, further comprising: receiving an indication of the set of time-frequency resources that further indicates resources allocated for switching between the first antenna port and the second antenna port of the one or more antenna ports of the UE, the set of time-frequency resources associated with the first subscription and the second subscription at least partially overlapping in time; and transmitting the UAI message that comprises the request for allocating the set of time-frequency resources that are non-overlapping in time based at least in part on the indication.

Aspect 11: The method of aspect 10, further comprising: receiving an updated set of time-frequency resources that are non-overlapping in time based at least in part on the UAI message.

Aspect 12: The method of any of aspects 1 through 11, further comprising: receiving a control information message that includes a listing of time-frequency resources including the set of time-frequency resources, wherein the listing of time-frequency resources are non-overlapping time-frequency resources to use for transmission of the first uplink signal associated with a first subscription and for transmission of the second uplink signal associated with the second subscription.

Aspect 13: The method of aspect 12, wherein the listing of time-frequency resources are non-overlapping based at least in part on slot offset of the non-overlapping time-frequency resources, periodicity of the non-overlapping time-frequency resources, or both.

Aspect 14: The method of any of aspects 1 through 13, wherein the first antenna port is associated with the first subscription and the second antenna port is associated with the second subscription.

Aspect 15: The method of any of aspects 1 through 14, wherein the dual-subscriber dual-active mode is associated with an activated UE capability.

Aspect 16: The method of any of aspects 1 through 15, wherein the first uplink signal and the second uplink signal comprise one or more SRS.

Aspect 17: A method for wireless communications at a network entity, comprising: receiving, from a UE, a UAI message that comprises a request for allocating a set of time-frequency resources that are non-overlapping in time, frequency, or both; and receiving, via the set of time-frequency resources, a first uplink signal associated with a first subscription of the UE multiplexed with a second uplink signal associated with a second subscription of the UE.

Aspect 18: The method of aspect 17, further comprising: receiving, via a first set of time resources of the set of time-frequency resources, the first uplink signal associated with the first subscription multiplexed in time with the second uplink signal associated with the second subscription; and receiving, via a second set of time resources of the set of time-frequency resources, the first uplink signal associated with the first subscription multiplexed in time with the second uplink signal associated with the second subscription.

Aspect 19: The method of aspect 18, further comprising: transmitting a resource allocation message indicating the first set of time resources and the second set of time resources, wherein the first set of time resources and the second set of time resources are non-overlapping in time.

Aspect 20: The method of any of aspects 17 through 19, further comprising: receiving, via a first set of frequency resources of the set of time-frequency resources, the first uplink signal associated with the first subscription multiplexed in frequency with the second uplink signal associated with the second subscription; and receiving, via a second set of frequency resources of the set of time-frequency resources, the first uplink signal associated with the first subscription multiplexed in frequency with the second uplink signal associated with the second subscription.

Aspect 21: The method of aspect 20, further comprising: transmitting a resource allocation message indicating the first set of frequency resources and the second set of frequency resources, wherein the first set of frequency resources and the second set of frequency resources are non-overlapping in frequency.

Aspect 22: The method of any of aspects 17 through 21, further comprising: receiving the request for allocating the set of time-frequency resources in at least one field of the UAI message, wherein the at least one field of the UAI message comprises a non-critical extension field.

Aspect 23: The method of any of aspects 17 through 22, wherein the UAI message further comprises a preferred time slot for transmission of the first uplink signal and the second uplink signal, a periodicity for transmission of the first uplink signal and the second uplink signal, and offset for transmission of the first uplink signal and the second uplink signal, an indication of a change of the set of time-frequency resources to a different set of time-frequency resources, or any combination thereof.

Aspect 24: The method of any of aspects 17 through 23, further comprising: transmitting an indication of the set of time-frequency resources that further indicates resources allocated for switching between a first antenna port and a second antenna port of one or more antenna ports of the UE, the set of time-frequency resources associated with the first subscription and the second subscription at least partially overlapping in time; and receiving the UAI message that comprises the request for allocating the set of time-frequency resources that are non-overlapping in time based at least in part on the indication.

Aspect 25: The method of aspect 24, further comprising: transmitting an updated set of time-frequency resources that are non-overlapping in time based at least in part on the UAI message.

Aspect 26: The method of any of aspects 17 through 25, further comprising: transmitting a control information message that includes a listing of time-frequency resources including the set of time-frequency resources, wherein the listing of time-frequency resources are non-overlapping time-frequency resources to use for transmission of the first uplink signal associated with a first subscription and for transmission of the second uplink signal associated with the second subscription.

Aspect 27: The method of aspect 26, wherein the listing of time-frequency resources are non-overlapping based at least in part on slot offset of the non-overlapping time-frequency resources, periodicity of the non-overlapping time-frequency resources, or both.

Aspect 28: The method of any of aspects 17 through 27, wherein the first uplink signal and the second uplink signal comprise one or more SRS.

Aspect 29: An apparatus for wireless communications at a UE, comprising a processor; memory coupled with the processor; and instructions stored in the memory and executable by the processor to cause the apparatus to perform a method of any of aspects 1 through 16.

Aspect 30: An apparatus for wireless communications at a UE, comprising at least one means for performing a method of any of aspects 1 through 16.

Aspect 31: A non-transitory computer-readable medium storing code for wireless communications at a UE, the code comprising instructions executable by a processor to perform a method of any of aspects 1 through 16.

Aspect 32: An apparatus for wireless communications at a network entity, comprising a processor; memory coupled with the processor; and instructions stored in the memory and executable by the processor to cause the apparatus to perform a method of any of aspects 17 through 28.

Aspect 33: An apparatus for wireless communications at a network entity, comprising at least one means for performing a method of any of aspects 17 through 28.

Aspect 34: A non-transitory computer-readable medium storing code for wireless communications at a network entity, the code comprising instructions executable by a processor to perform a method of any of aspects 17 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
activating a dual-subscriber dual-active mode for the UE to communicate using at least two subscriptions of the UE via one or more antenna ports of the UE;
transmitting, via a first antenna port of the one or more antenna ports of the UE and using a set of time-frequency resources, a first uplink signal associated with a first subscription of the at least two subscriptions multiplexed with a second uplink signal associated with a second subscription of the at least two subscriptions based at least in part on activation of the dual-subscriber dual-active mode; and
transmitting, via a second antenna port of the one or more antenna ports of the UE and using the set of time-frequency resources, the first uplink signal associated with the first subscription of the at least two subscriptions multiplexed with the second uplink signal associated with the second subscription of the at least two subscriptions of the UE based at least in part on activation of the dual-subscriber dual-active mode.

2. The method of claim 1, further comprising:
transmitting, via the first antenna port of the one or more antenna ports of the UE and using a first set of time resources of the set of time-frequency resources, the first uplink signal associated with the first subscription multiplexed in time with the second uplink signal associated with the second subscription; and
transmitting, via the second antenna port of the one or more antenna ports of the UE and using a second set of time resources of the set of time-frequency resources, the first uplink signal associated with the first subscription multiplexed in time with the second uplink signal associated with the second subscription.

3. The method of claim 2, further comprising:
receiving a resource allocation message indicating the first set of time resources and the second set of time resources, wherein the first set of time resources and the second set of time resources are non-overlapping in time.

4. The method of claim 1, further comprising:
transmitting, via the first antenna port of the one or more antenna ports of the UE and using a first set of frequency resources of the set of time-frequency resources, the first uplink signal associated with the first subscription multiplexed in frequency with the second uplink signal associated with the second subscription; and
transmitting, via the second antenna port of the one or more antenna ports of the UE and using a second set of frequency resources of the set of time-frequency resources, the first uplink signal associated with the first subscription multiplexed in frequency with the second uplink signal associated with the second subscription.

5. The method of claim 4, further comprising:
receiving a resource allocation message indicating the first set of frequency resources and the second set of frequency resources, wherein the first set of frequency resources and the second set of frequency resources are non-overlapping in frequency.

6. The method of claim 1, further comprising:
transmitting a UE assistance information message that comprises a request for allocating the set of time-frequency resources that are non-overlapping in time; and
transmitting the first uplink signal associated with the first subscription and the second uplink signal associated with the second subscription via the first antenna port and the second antenna port of the one or more antenna ports of the UE using the set of time-frequency resources that are non-overlapping in time based at least in part on the UE assistance information message.

7. The method of claim 6, further comprising:
transmitting the request for allocating the set of time-frequency resources in at least one field of the UE assistance information message.

8. The method of claim 7, wherein the at least one field of the UE assistance information message comprises a non-critical extension field.

9. The method of claim 6, wherein the UE assistance information message further comprises a preferred time slot for transmission of the first uplink signal and the second uplink signal, a periodicity for transmission of the first uplink signal and the second uplink signal, an offset for transmission of the first uplink signal and the second uplink signal, an indication of a change of the set of time-frequency resources to a different set of time-frequency resources, or any combination thereof.

10. The method of claim 6, further comprising:
receiving an indication of the set of time-frequency resources that further indicates resources allocated for switching between the first antenna port and the second antenna port of the one or more antenna ports of the UE, the set of time-frequency resources associated with the first subscription and the second subscription at least partially overlapping in time; and
transmitting the UE assistance information message that comprises the request for allocating the set of time-frequency resources that are non-overlapping in time based at least in part on the indication.

11. The method of claim 10, further comprising:
receiving an updated set of time-frequency resources that are non-overlapping in time based at least in part on the UE assistance information message.

12. The method of claim 1, further comprising:
receiving a control information message that includes a listing of time-frequency resources including the set of time-frequency resources, wherein the listing of time-frequency resources are non-overlapping time-frequency resources to use for transmission of the first uplink signal associated with a first subscription and for transmission of the second uplink signal associated with the second subscription.

13. The method of claim 12, wherein the listing of time-frequency resources are non-overlapping based at least in part on slot offset of the non-overlapping time-frequency resources, periodicity of the non-overlapping time-frequency resources, or both.

14. The method of claim 1, wherein the first antenna port is associated with the first subscription and the second antenna port is associated with the second subscription.

15. The method of claim 1, wherein the dual-subscriber dual-active mode is associated with an activated UE capability.

16. The method of claim 1, wherein the first uplink signal and the second uplink signal comprise one or more sounding reference signals.

17. A method for wireless communications at a network entity, comprising:
receiving, from a user equipment (UE), a UE assistance information message that comprises a request for allocating a set of time-frequency resources that are non-overlapping in time, frequency, or both; and
receiving, via the set of time-frequency resources, a first uplink signal associated with a first subscription of the UE multiplexed with a second uplink signal associated with a second subscription of the UE.

18. The method of claim 17, further comprising:
receiving, via a first set of time resources of the set of time-frequency resources, the first uplink signal associated with the first subscription multiplexed in time with the second uplink signal associated with the second subscription; and
receiving, via a second set of time resources of the set of time-frequency resources, the first uplink signal associated with the first subscription multiplexed in time with the second uplink signal associated with the second subscription.

19. The method of claim 18, further comprising:
transmitting a resource allocation message indicating the first set of time resources and the second set of time resources, wherein the first set of time resources and the second set of time resources are non-overlapping in time.

20. The method of claim 17, further comprising:
receiving, via a first set of frequency resources of the set of time-frequency resources, the first uplink signal associated with the first subscription multiplexed in frequency with the second uplink signal associated with the second subscription; and
receiving, via a second set of frequency resources of the set of time-frequency resources, the first uplink signal associated with the first subscription multiplexed in frequency with the second uplink signal associated with the second subscription.

21. The method of claim 20, further comprising:
transmitting a resource allocation message indicating the first set of frequency resources and the second set of frequency resources, wherein the first set of frequency resources and the second set of frequency resources are non-overlapping in frequency.

22. The method of claim 17, further comprising:
receiving the request for allocating the set of time-frequency resources in at least one field of the UE assistance information message, wherein the at least one field of the UE assistance information message comprises a non-critical extension field.

23. The method of claim 17, wherein the UE assistance information message further comprises a preferred time slot for transmission of the first uplink signal and the second uplink signal, a periodicity for transmission of the first uplink signal and the second uplink signal, and offset for transmission of the first uplink signal and the second uplink signal, an indication of a change of the set of time-frequency resources to a different set of time-frequency resources, or any combination thereof.

24. The method of claim 17, further comprising:
transmitting an indication of the set of time-frequency resources that further indicates resources allocated for switching between a first antenna port and a second antenna port of one or more antenna ports of the UE, the set of time-frequency resources associated with the first subscription and the second subscription at least partially overlapping in time; and
receiving the UE assistance information message that comprises the request for allocating the set of time-frequency resources that are non-overlapping in time based at least in part on the indication.

25. The method of claim 24, further comprising:
transmitting an updated set of time-frequency resources that are non-overlapping in time based at least in part on the UE assistance information message.

26. The method of claim 17, further comprising:
transmitting a control information message that includes a listing of time-frequency resources including the set of time-frequency resources, wherein the listing of time-frequency resources are non-overlapping time-frequency resources to use for transmission of the first uplink signal associated with a first subscription and for transmission of the second uplink signal associated with the second subscription.

27. The method of claim 26, wherein the listing of time-frequency resources are non-overlapping based at least in part on slot offset of the non-overlapping time-frequency resources, periodicity of the non-overlapping time-frequency resources, or both.

28. The method of claim 17, wherein the first uplink signal and the second uplink signal comprise one or more sounding reference signals.

29. An apparatus for wireless communications at a user equipment (UE), comprising:
a processor;
memory coupled with the processor; and
instructions stored in the memory and executable by the processor to cause the apparatus to:
activate a dual-subscriber dual-active mode for the UE to communicate using at least two subscriptions of the UE via one or more antenna ports of the UE;
transmit, via a first antenna port of the one or more antenna ports of the UE and using a set of time-frequency resources, a first uplink signal associated with a first subscription of the at least two subscriptions multiplexed with a second uplink signal associated with a second subscription of the at least two subscriptions based at least in part on activation of the dual-subscriber dual-active mode; and
transmit, via a second antenna port of the one or more antenna ports of the UE and using the set of time-frequency resources, the first uplink signal associated with the first subscription of the at least two subscriptions multiplexed with the second uplink signal associated with the second subscription of the at least two subscriptions of the UE based at least in part on activation of the dual-subscriber dual-active mode.

30. An apparatus for wireless communications at a network entity, comprising:
a processor;
memory coupled with the processor; and
instructions stored in the memory and executable by the processor to cause the apparatus to:
receive, from a user equipment (UE), a UE assistance information message that comprises a request for allocating a set of time-frequency resources that are non-overlapping in time, frequency, or both; and
receive, via the set of time-frequency resources, a first uplink signal associated with a first subscription of the UE multiplexed with a second uplink signal associated with a second subscription of the UE.
